(19) United States
(12) Patent Application Publication
(10) Pub. No.: US 2007/0088706 A1
(43) Pub. Date: Apr. 19, 2007

(54) Methods and devices for simultaneously accessing multiple databases

(76) Inventor: Thomas Christopher Goff, Springfield, VA (US)

Correspondence Address: HARNESS, DICKEY & PIERCE, P.L.C., P.O. BOX 8910, RESTON, VA, 20195, US

(21) Appl. No.: 11/340,674

(22) Filed: Jan. 27, 2006

Related U.S. Application Data
(60) Provisional application No. 60/726,681, filed on Oct. 17, 2005.

(51) Int. Cl. G06F 17/30

(52) U.S. Cl. 707/10

(57) ABSTRACT

Multiple databases are accessed simultaneously by forwarding scripts in a parallel or “multi-threaded” manner. Results returned in response to the execution of multiple databases are then aggregated for display or storage purposes. These novel features allow for quicker and more efficient management of databases in computer networks, and permit the retrieval and aggregation of data from multiple databases.

### RELATED APPLICATION

This application claims the benefit of U.S. Provisional Application No. 60/726,681 filed on Oct. 17, 2005.

### BACKGROUND OF THE INVENTION

In a network of any appreciable size, there will exist a number of database servers, where each database server contains one or more databases. In fact, there may be many database servers, each containing multiple databases, within the same network.

From time to time, databases in the network or in several different networks must be accessed for the purpose of performing operations that relate to one or more databases. Common operations include the retrieval of existing data, storage of new data, removing or manipulating data, executing database programs, and performing tasks to ensure that databases are working properly and efficiently. Typically, databases will be accessed by some kind of central controller or control unit (collectively referred to as “controller” hereafter). When one or more of the databases need to be accessed for some reason, applications embedded within the controller are activated. More specifically, the controller may utilize so called “scripts” that are forwarded to one or more databases and are executed to return data, or perform a particular function involving the databases. The applications that exist today (sometimes referred to as “tools”) require a controller to access each database one at a time (i.e., serially). For example, if three databases must be accessed and each database resides on a different database server, then existing controllers will first establish a connection with a first database before creating a connection with a next database, and so on.

This process is slow and time-consuming, especially when multiple scripts need to be sent to a large number of databases or when many scripts need to be sent at the same, or substantially the same, time.

One tool made by Symantec, Inc. attempts to overcome the disadvantages inherent in tools that execute scripts or batches of scripts in a serial fashion. However, those skilled in the art have recognized that this tool has its own inherent disadvantages and is cumbersome to use.

Accordingly, it is desirable to provide methods and devices that allow multiple databases to be accessed simultaneously.

### SUMMARY OF THE INVENTION

We have recognized that in order to access or perform operations on multiple databases, which reside on one or more database servers, substantially simultaneously, one or more scripts should be forwarded to numerous “target databases” substantially simultaneously.

Hereinafter, the term “identifier” is used to denote a set of values that can be utilized to identify and establish a connection to a database. For example, a collection consisting of a database name, and a name/address of the database server that contains the database can be used as an identifier. This collection may also include one or more of the group consisting of: a communication port and/or protocol to a database server, a connection timeout, an authentication type and/or mode, a user name, and a password.

In order to forward scripts to multiple databases, the present invention provides for an execution engine that is, generally speaking, operable to: (1) receive a code package that includes one or more scripts and one or more database identifiers, wherein each script is associated with one or more of the identifiers; and (2) forward one or more of the scripts to one or more target databases substantially simultaneously, where each target database is identified by the identifiers that are associated with each script. The scripts may be forwarded in accordance with a number of different forwarding orders.

In accordance with alternative embodiments of the present invention the forwarding order may be specified in the code package or determined by the execution engine.

When a code package includes a type of script referred to as a “reference query” and associated database identifiers, execution engines in accordance with the present invention may be further operable to: (1) forward each such reference query (there may be more than one) to one or more databases, indicated by the identifiers as being associated to the reference query to be forwarded, substantially simultaneously prior to forwarding one or more scripts; (2) receive database identifiers in response to a forwarded reference query; and (3) forward one or more scripts to target databases that are identified by the received identifiers.

Execution engines provided by the present invention may also be operable to: (1) verify that a valid connection can be established with each target database associated with one or more scripts substantially simultaneously prior to forwarding any script to one or more of the associated target databases; and (2) forward one or more scripts to one or more associated target databases in accordance with a connection limit, wherein the connection limit is selected from at least the group consisting of: (i) a maximum number of simultaneous connections to all servers and databases, (ii) a maximum number of simultaneous connections to each server, and (iii) a maximum number of simultaneous connections to each database.

In accordance with yet additional embodiments of the present invention, an execution engine may include numerous error and pause policies.

In addition to execution engines, the present invention provides for aggregation units that are operable to: (a) receive one or more ordered sets of data in response to a forwarded script from one or more associated target databases, wherein each set of data (“dataset”) comprises one or more ordered tables; (b) discover an ordered set of columns (“column schema”) within each table (“datatable”) contained in a received dataset; and (c) aggregate one or more datatables with common column schema in accordance with an aggregation order policy.

The aggregation order policy may be selected from at least the group consisting of: aggregate datatables according to a received dataset order; aggregate datatables ignoring a dataset order; aggregate datatables according to a datatable order within each received dataset; aggregate datatables ignoring a datatable order within each dataset; aggregate datatables according to an order of columns within each column schema; aggregate datatables ignoring an order of columns within each column schema; and various combinations of the above mentioned options.

Aggregation units provided by the present invention may be further operable to label each aggregated datatable and pass one or more aggregated datatables along with the labels to, for example, a display unit for display purposes or to a database or file in order to store aggregated datatables, once all datatables returned from all target databases associated with one or more of the forwarded scripts have been aggregated.

In yet a further embodiment of the invention, an aggregation unit may be operable to: (a) receive one or more ordered datasets in response to a forwarded script, wherein each dataset comprises one or more datatables; (b) discover a column schema within each datatable; (c) assign each column schema to a tag; (d) assign each datatable a tag that corresponds to its column schema tag subject to an aggregation order policy; and (e) pass datatables with the assigned tags to external units (e.g., display units, databases, files) in order to display or store the received datatables in an aggregated format.

In practice, an execution engine may be combined with an aggregation unit to form an application, all of which may reside on a computer readable medium of some sort or be downloaded onto such a medium. The application/computer readable medium may form part of a controller (e.g., computer) or the like.

In accordance with alternative embodiments of the present invention, many different applications may be formed. One of these is the execution engine/aggregation unit combination discussed above. Another is a combination of an execution engine, aggregation unit and code package unit.

The present invention also provides for embodiments where an application formed from a combination of an execution engine, aggregation unit and code package unit is further combined with a display unit that is responsible for displaying outputs from an application.

In still additional embodiments, an application may comprise only an execution engine, or only an aggregation unit or a code package unit.

These and other aspects of the present invention are exemplified by the figures and description of the invention that follows.

### BRIEF DESCRIPTION OF THE DRAWINGS

FIG. 1 depicts an example of a controller used to simultaneously access multiple databases in accordance with one embodiment of the present invention.

FIG. 2 depicts an example of a controller used to simultaneously access multiple databases using a one script at a time forwarding order in accordance with one embodiment of the present invention.

FIG. 3 depicts an example of a controller used to simultaneously access multiple databases using a one database at a time forwarding order in accordance with one embodiment of the present invention.

FIG. 4 depicts an example of a controller used to simultaneously access multiple databases using a one server at a time forwarding order in accordance with one embodiment of the present invention.

FIG. 5 depicts an example of associating scripts to target databases in a code package by using a Container in accordance with one embodiment of the present invention.

FIG. 6 depicts a diagram illustrating steps which may be performed by the present invention to forward a script to target databases in accordance with embodiments of the present invention.

FIG. 7 depicts an example of database identifiers stored in databases shown in FIG. 6, which may be retrieved by an execution engine when a code package includes a reference query in accordance with embodiments of the present invention.

FIG. 8 depicts exemplary images relating to the creation of a new database code package in accordance with one embodiment of the present invention.

FIG. 9 depicts the composition of an exemplary code release package in accordance with one embodiment of the present invention.

FIG. 10 depicts the storage of a code release package shown in FIG. 6, for example, in a .cpa file in accordance with one embodiment of the present invention.

FIG. 11 depicts an exemplary use of a script in a package in accordance with one embodiment of the present invention.

FIG. 12 depicts an example of a Container where all database names are identical in accordance with one embodiment of the present invention.

FIG. 13 depicts an example of script organization in accordance with embodiments of the present invention.

FIG. 14 depicts an example of associating scripts with target databases by inheriting a Container associated with a parent node in accordance with embodiments of the present invention.

FIG. 15 depicts a diagram that illustrates an example of the execution of scripts in accordance with a root, folder and sub-folder organization in accordance with one embodiment of the present invention.

FIG. 16 depicts an example of associating scripts with target database by using a Dynamic Container in accordance with one embodiment of the present invention.

FIG. 17 depicts a block diagram that illustrates a process which may be used to execute scripts using the one script at a time forwarding order in accordance with one embodiment of the present invention.

FIG. 18 depicts a block diagram that illustrates another process which may be used to execute scripts using the one database at a time forwarding order in accordance with another embodiment of the present invention.

FIGS. 19-24 depict various exemplary inputs and outputs from aggregation units provided by the present invention.

FIGS. 25-28 depict block diagrams that illustrate various aggregation processes which may be used to aggregate datatables in accordance with embodiments of the present invention.

### DETAILED DESCRIPTION OF THE INVENTION

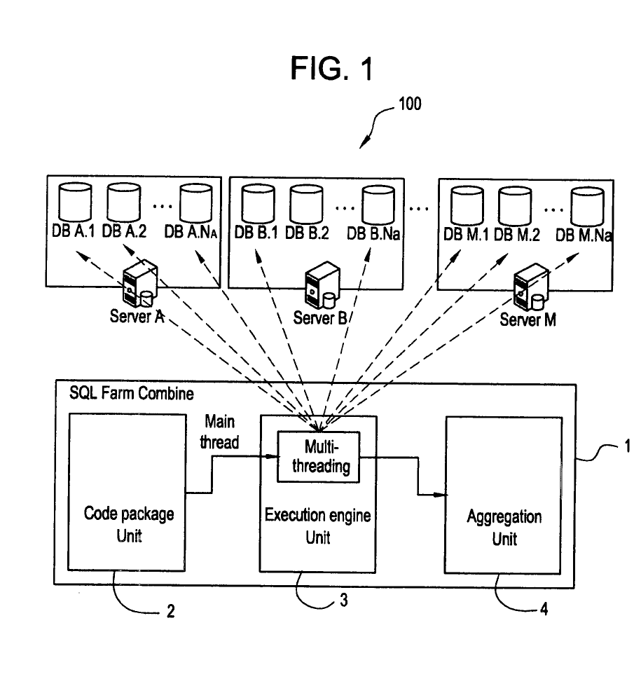

Referring to FIG. 1, there is shown an example of a controller 1 which is used to simultaneously access multiple databases in accordance with one embodiment of the present invention. As shown, the controller 1 may comprise a code package unit 2, execution engine unit 3 (or “execution engine”) and a data aggregation unit 4. Though shown as three separate units, it should be understood that one or more of these units may be combined to form fewer units or further separated to form more than three units.

Each of the components 2-4 may take the form of software, firmware or hardware. For example, one or more of the components 2-4 may take the form of a software application that is stored on a computer readable medium 6, such as a compact disc (CD), floppy disk, tape, hard drive, memory, processor or some combination of the just mentioned devices. More specifically, the execution engine unit 3 and aggregation unit 4 may be combined into a software application that makes up, or is part of, a first type of controller. Alternatively, all three components 2-4 may be combined into a software application that makes up, or is part of, a second type of controller. Each of the first and second type of controllers 1 may comprise a computer or the like that operates automatically, or is operated by a database manager, for example, responsible for operating and maintaining databases.

In yet further embodiments of the invention, one or more of the components 2-4 may be downloaded into one or more of the computer readable mediums described above.

In still additional embodiments of the invention, the first and second type of controller may be combined with a display unit 5.

Though two types of applications and controllers are discussed above, it should be understood that the present invention provides for any number of application and controller types that includes just a single component 2-4 or some combination of the components 2-4 with, or without, the display unit 5.

In practice, the applications provided by the present invention may be stored on a medium that operates without the knowledge of a user, or may comprise a software tool used by software developers and programmers. Additionally, it should be understood that the applications provided by the present invention may be used to create other applications which necessarily use the inventive applications as a starting point or core.

It should be understood that controller 1 shown in FIG. 1 may include other elements (not shown) that allow controller 1 to communicate with databases, files, storage components, and other devices. These elements are known by those skilled in the art and are not necessary for an understanding of the present invention.

Referring back to FIG. 1, also shown are database servers A, B, . . . , M, where M represents the last database server in an environment 100. Each database server A, B, . . . , M is also shown comprising one or more databases (e.g., DB A.1).

In accordance with the present invention, the execution engine unit 3 is operable to receive a code package from the code package unit 2. Within each code package there may be one or more scripts and one or more database identifiers, where each script is associated with one or more of the identifiers. Upon receiving the code package and detecting the scripts and their associated database identifiers, the execution engine unit 3 is operable to forward one or more of the scripts to one or more target databases (in this case one or more of the databases in database servers A, B, . . . , M shown in FIG. 1). Each of the target databases that is forwarded a script is identified by an identifier associated with each script. In accordance with the present invention, the one or more scripts are forwarded to one or more target databases substantially simultaneously.

Because the present invention is capable of forwarding one or more scripts substantially simultaneously to one or more target databases, a user can more efficiently access, perform operations, or retrieve data from multiple databases in parallel. More specifically, a user can now deploy the same script, or many scripts, to a large number of different databases on one or more database servers, in substantially less time than previously thought possible.

In accordance with the present invention, during any given time period, one or more connections between the controller 1 and a plurality of databases may exist in parallel with one another. This way, multiple scripts can be forwarded to, and executed in, one or more databases at the same, or substantially the same, time.

In addition to creating multiple accesses (sometimes referred to as “threads”) and forwarding scripts substantially simultaneously, the present invention provides for a number of options which allow a user or database manager responsible for the operation of environment 100 to select an order (“forwarding order”) in which scripts are forwarded from the controller 1 and the databases contained in database servers A, B, . . . , M.

For example, in accordance with one alternative embodiment of the present invention, the execution engine unit 3 may forward the same script, in accordance with a script order, to each of its associated target databases substantially simultaneously before a next script in the order is forwarded. To demonstrate this technique, suppose a user has elected to forward scripts in an order where the first script is given the number one, the second script is given the number two, and so forth and so on. Given the script order of one, two, . . . , k, (where “k” is the last script in the order) the execution engine would forward script one to each target database associated with the script substantially simultaneously before it would forward script two to any of its associated target databases.

Again, it should be understood that the target databases are those databases that were identified by database identifiers indicated within the code package.

After an execution engine has completed forwarding the first script in the order, it then repeats the process for each next script (e.g., the second script in the order), until each script in the order has been forwarded to each of its associated target databases.

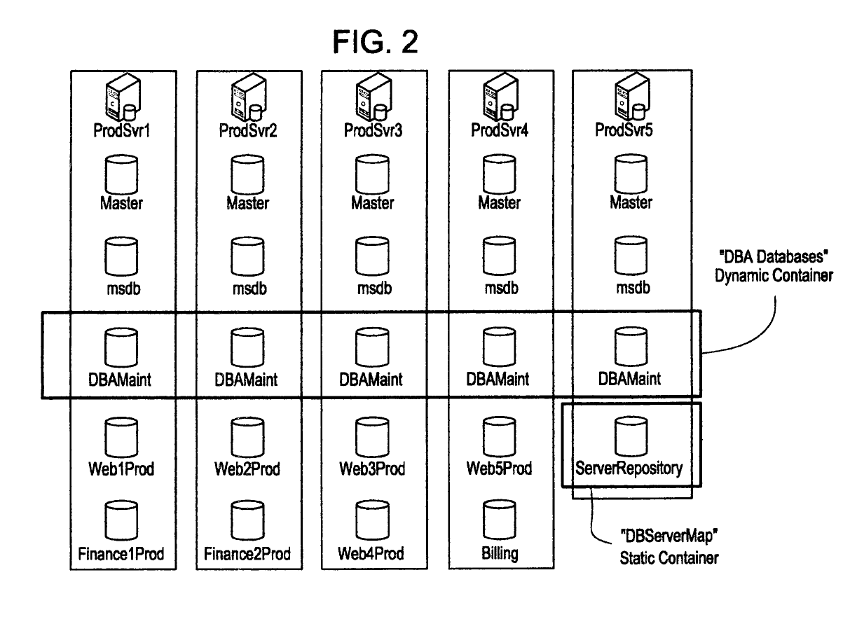

The above process may be described as a “one script at a time” method of forwarding scripts. This method is graphically illustrated in FIG. 2, where an execution engine 203 accepts a code package that contains three scripts, from a code package unit 202. Scripts in this sample code package are listed according to their script order, i.e., Script 1 is the first script to be forwarded, Script 2 is the second script, and Script 3 is the third script. Furthermore, target databases associated with each script are listed next to each script. In other words, Script 1 is associated with databases DB A.1, DB A.2, and DB M.1, Script 2 is associated with databases DB A.2 and DB M.1, and Script 3 is associated with DB A.1, DB A.2, and DB B.3. Under the one script at a time forwarding order, Script 1 is forwarded first to all of its associated target databases substantially simultaneously; Script 2 is then forwarded to its associated target databases, followed by the forwarding of Script 3, substantially simultaneously.

The present invention also provides for other methods of forwarding scripts, in particular, scripts may be forwarded “one database at a time” or “one server at a time”, to name just two of the many methods provided by the present invention. These two optional features of the present invention can be demonstrated as follows.

Upon receiving a code package, the execution engine unit 3 may forward each script in the code package in accordance with a script order, to the same associated target database, where the target database is selected in accordance with its own target database order. In particular, each script may be so forwarded to a target database selected from such an order before any scripts are forwarded to a next associated target database. In this manner, each script within the code package that is associated with the same target database may be forwarded to a database before any scripts are forwarded to any other target database. This process may be referred to as a “one database at a time” method of forwarding scripts.

After each script in the code package is forwarded to the same associated target database (e.g., to the first target database) the process is repeated for a next target database in the order.

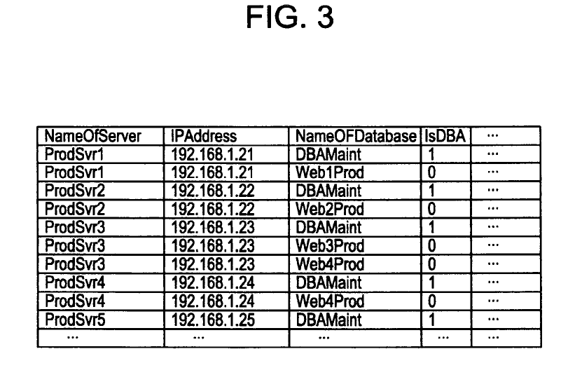

The one database at a time technique is exemplified in FIG. 3. In this figure, a code package unit 302 consists of a code package with script order given by: Script 1, Script 2, and Script 3. Target databases listed next to each script are those databases associated with the script (e.g., Script 1 is associated with databases DB A.1, DB A.2, and DB M.1). With respect to the one database at a time option, once the execution engine unit 303 accepts the code package, scripts are forwarded to a first database according to the script order (e.g., Script 1 is forwarded to DB A.1 and then Script 2 is forwarded to DB A.1, as shown in FIG. 3), then to a next database (e.g., Script 1 is sent to DB A.2, followed by the forwarding of Script 2 and then Script 3 to DB A.2), and so forth and so on. This process is repeated until all scripts have been forwarded to their associated target databases.

With respect to the “one server at a time” option, a similar process may be followed. If such an option is selected, then the execution engine unit 3 may be operable to forward each script in the code package in accordance with a script order to one or more associated target databases within the same server substantially simultaneously. In addition, the server is selected in accordance with a server order.

The “one server at a time” option allows a user or manager to update, access, retrieve data, or otherwise control each database server within their environment one at a time. To do so, each script in a code package that is associated with any of the databases within a given server must be sent to those databases before any script associated with a database in another server is forwarded. Once each and every script in the code package that is associated with a database within the first server has been forwarded, then scripts associated with databases in a next server may be forwarded. This process continues until the last server is reached at which point all the scripts that are associated with databases in this last server are sent.

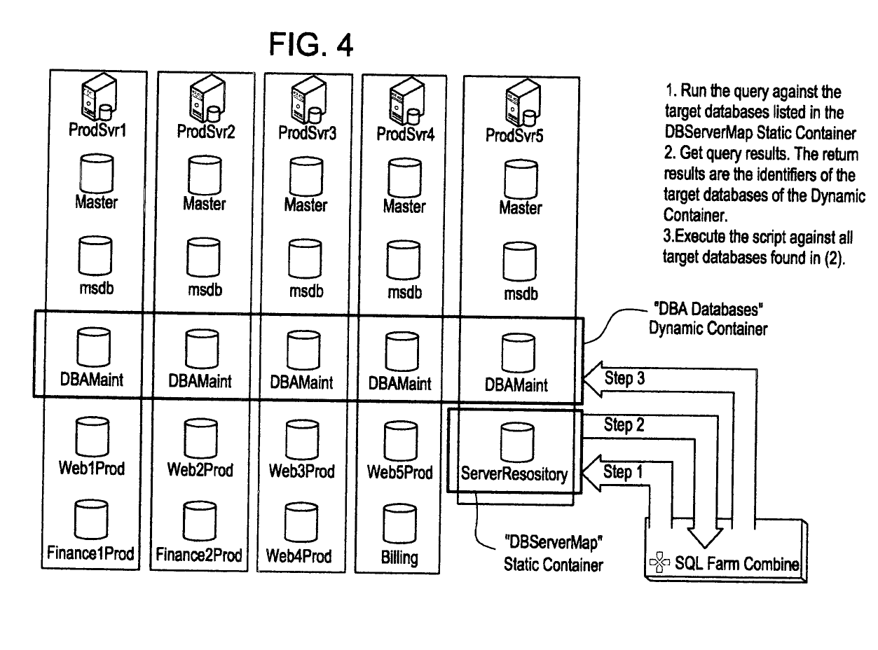

To demonstrate the one server at a time option, we refer to FIG. 4, where the code package in the code package unit 402 contains three scripts. In this code package, the script order is Script 1, Script 2, and Script 3. Databases associated with each script are listed next to the script (e.g., Script 1 is associated with databases DB A.1, DB A.2, and DB M.1). When an execution engine 403 operates under the one server at a time option, scripts are forwarded to databases in a first server in accordance with the script order, substantially simultaneously, before any scripts are sent to databases on any other server. For example, in FIG. 4, Script 1 is sent to DB A.1 and DB A.2 (both of which are in Server A) substantially simultaneously, Script 2 is sent to DB A.2, and Script 3 is sent to DB A.1 and DB A.2 substantially simultaneously, before any scripts are sent to databases on a next server. Then, scripts are forwarded to databases on a next database server (e.g., Server B), and the process repeats until all scripts are forwarded to all target databases associated with each script.

The script, database or server orders discussed above may be included within a code package, or alternatively, may be determined by an execution engine.

Thus far, we have established that each script in the code package is associated with one or more target databases. However, we have not yet explained how the association is performed. In fact, the present invention allows scripts to be associated with target databases in numerous ways. For example, in one embodiment of the present invention, scripts can be associated with target databases directly, as illustrated in FIG. 4. Using this technique, an identifier of each target database associated with each script is indicated in the code package. Continuing with the example presented in FIG. 4, Script 1 is associated with databases DB A.1, DB A.2, and DB M.1, Script 2 is associated with databases DB A.2 and DB M.1, and Script 3 is associated with databases DB A.1, DB A.2, and DB B.3.

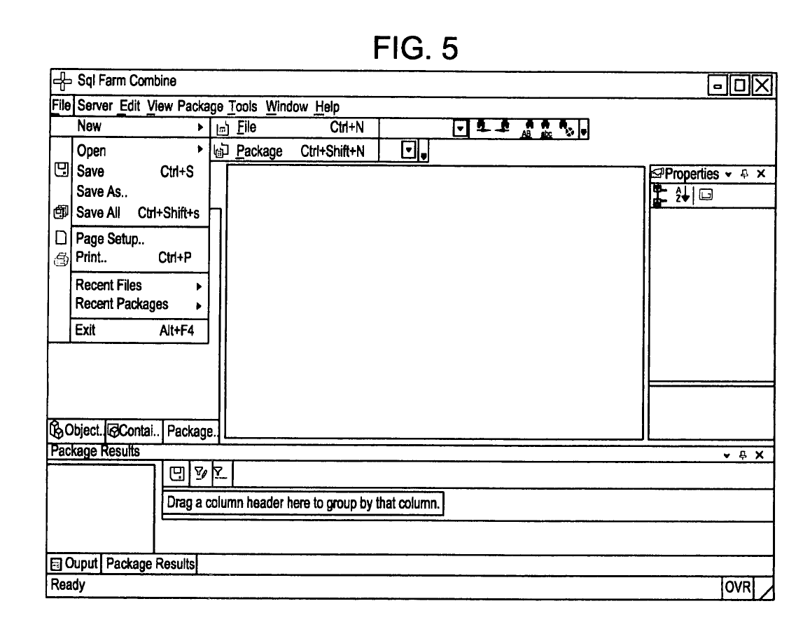

In another embodiment of the present invention, scripts can be associated with target databases by mapping each script or group of scripts in the code package to a group of identifiers of one or more databases (referred to as a “Container”), as demonstrated in FIG. 5. Using this option, each script is associated with all target databases that are identified by identifiers in a Container. In FIG. 5, each script in the code package 502 is associated with a name of a Container. For example, the script titled “Create Web tables” 504 in the code package 502 is associated with a Container named “Web Databases” through the mapping 503. Therefore, this script is associated with all target databases identified by the identifiers in the Container 501.

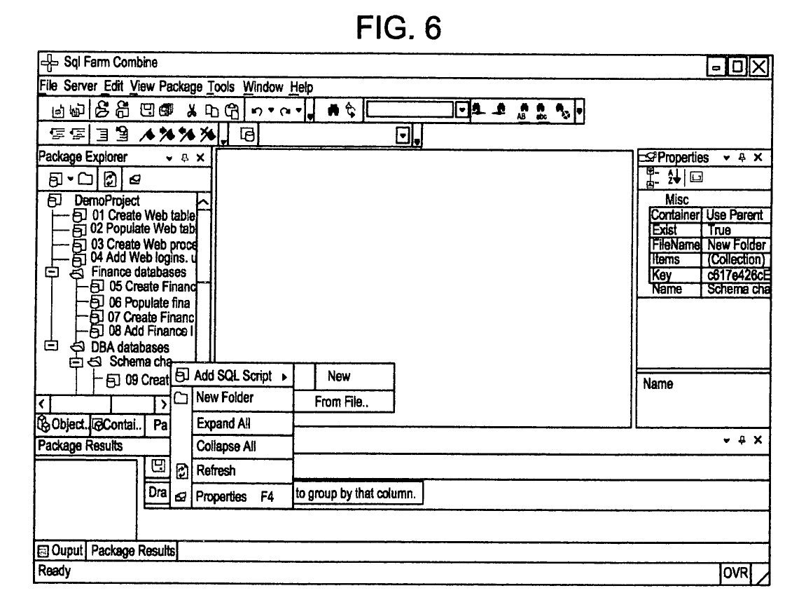

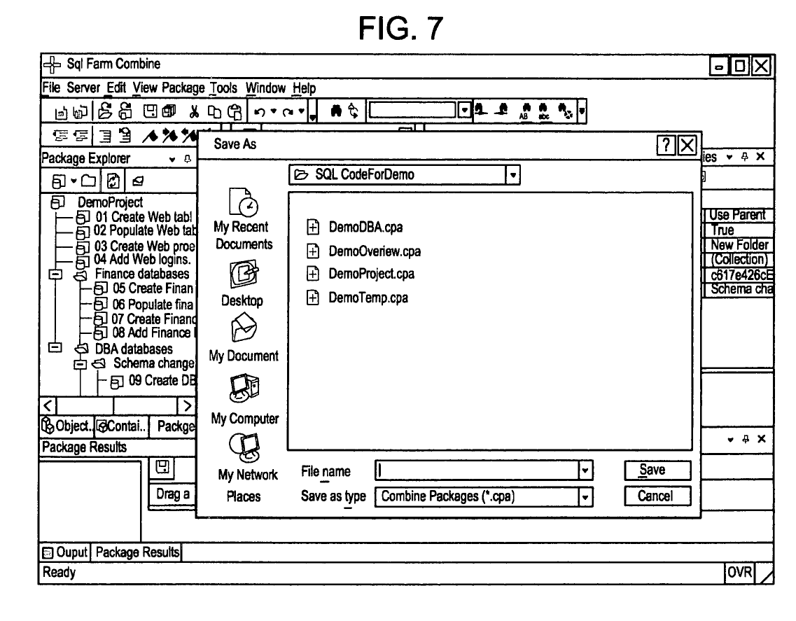

The present invention also provides other methods for associating scripts with target databases. In yet another embodiment of the present invention, database identifiers associated with one or more scripts can be retrieved from data sources, including databases, files, registries, etc. When this option is used, identifiers may not be explicitly listed in the code package. Instead, the code package contains instructions/directives that can be used to retrieve the identifiers, and an association between scripts in the code package and the instructions/directives that reflect the association between each script and target databases identified by the retrieved identifiers. Then, when a code package is passed to the execution engine unit 3, target databases associated with each script are identified either by the code package unit 2 or the execution engine unit 3, by retrieving identifiers from one or more data sources. One key advantage of this technique is that when scripts are forwarded to a large number of databases and servers, a user or manager can store the identifiers of target databases in their own data storage devices (e.g., databases), and associate scripts with target databases by retrieving identifiers from the data stores. This omits the need to specify a (potentially) long list of associated target databases in a code package. This technique is demonstrated in FIG. 6 and FIG. 7.

Starting with FIG. 6, it will be assumed that a code package contains a type of script termed “reference query” that can be forwarded to, and executed against, target databases associated with this script to return database identifiers. In this example, a single target database is associated directly with the reference query, namely the DataSource database 601. This database contains a table 701 named DBIdentifiers, and FIG. 7 displays the content of this table 701. Shown in FIG. 6 too is the content of a sample reference query script 603. In this example, the execution of the sample reference query script 603 against the DataSource database returns all the records of the DBIdentifiers table 701. Referring back to FIG. 6, when a code package is passed from the code package unit to the execution engine unit 602, the execution engine unit forwards the reference query to its associated target databases (in this case the DataSource database 601). Then, database identifiers returned in response to the forwarded reference query are associated with one or more scripts in the code package (in this example the databases DB A.3, DB B.3, DB C.3, DB D.3, and DB E.3). Once the association is established, scripts in the code package are forwarded to the target databases identified by the identifiers returned from the execution of the reference query, substantially simultaneously.

To summarize, in accordance with one embodiment of the present invention, the execution engine unit 3 may be operable to forward one or more reference queries in the package to one or more databases, indicated by the database identifiers as being associated to each reference query, substantially simultaneously prior to the forwarding of other scripts. The execution engine unit 3 may be operable to receive database identifiers in response to each forwarded reference query and then forward one or more scripts to target databases that are identified by the received identifiers.

The many techniques provided by the present invention to associate scripts with target databases can be combined with other options set forth above and below. For example, the forwarding order (e.g., one script at a time, one database at a time, one server at a time) can be set in a code package or determined by an execution engine, together with one or more methods of associating scripts with target databases. In addition, one method can be used to associate some scripts with target databases in a code package, while different methods can be utilized to associate target databases to some other scripts or groups of scripts.

In our discussion so far it has been assumed that a valid connection can always be established between the controller 1 and servers or target databases. In practice, this may not be the case.

Realizing this, the present invention includes options which verify that a valid connection exists before any scripts are forwarded.

In one embodiment of the present invention, the execution engine unit 3 may be further operable to verify that a valid connection can be established with each target database associated with one or more scripts in a received code package prior to forwarding the scripts to one or more target databases that are associated with the script or scripts. This may save the user or manager a significant amount of time, and eliminate script-forwarding errors that may occur due to unreachable databases. For example, if such an option did not exist, then scripts may be forwarded to databases regardless of whether or not a valid connection exists. Absent a valid connection, the scripts would not be received or executed properly at a database. In essence, without the ability to verify that a valid connection exists, the controller 1 would be wasting its time and resources forwarding scripts which cannot otherwise be executed, etc. Thus, the ability to verify that a valid connection exists prior to forwarding scripts (“connection verification”) makes the controllers and/or execution engines provided by the present invention more efficient than existing controllers/execution engines.

In accordance with still another embodiment of the present invention, the code package unit 2 can instruct the execution engine unit 3 to either invoke or discard the connection verification feature. In addition, the connection verification option can be either enabled or disabled by the execution engine unit 3.

In some cases, it may take a significant amount of time for a database to execute a forwarded script. When this is the case, in order to ensure that execution engines provided by the present invention do not terminate (i.e., close, disconnect) a connection to a database while the database is still executing a forwarded script, a user or manager can set a maximum time limit for script execution (referred to as “execution timeout”) in a code package. In yet a further embodiment of the present invention, an execution timeout can be associated with a script or group of scripts in a code package. In the absence of such an execution timeout in the code package, the execution timeout will be set to a default execution timeout value, which can be configured by a user/manager either at the code package unit 2 or the execution engine unit 3.

In practice, the forwarding of scripts must also take into consideration the bandwidth and throughput capabilities of a given network, limitations on the throughput of the software or firmware or computer readable mediums that contain execution engines, as well as the load on the target databases and their servers. In order to give a user or manager the flexibility to change how scripts should be forwarded to account for bandwidth/throughput utilization, database and server load, and other limitations imposed by network devices involving the maximum number of allowable connections, the present invention provides a user/manager the ability to apply limits on the number of scripts that will be forwarded to the database servers at the same time. More specifically, in accordance with the present invention the execution engine unit 3 may be further operable to forward one or more scripts to one or more associated target databases substantially simultaneously in accordance with a “connection limit”. The connection limit may, generally speaking, be selected from at least a group consisting of: a maximum number of simultaneous connections to all servers and databases, a maximum number of simultaneous connections to each server, and a maximum number of simultaneous connections to each database, to give just a few examples.

Taking these options one at a time, the first option allows a manager to set a maximum number of concurrent connections. By so controlling the maximum number of connections to all databases and servers, a manager may be assured that a network does not become overloaded, and that connections from the execution engine to databases and servers are not blocked by network devices (e.g., firewalls, intrusion detection or prevention systems) that may limit the number of permitted connections.

Similarly, the second option allows the manager to apply a maximum number of concurrent connections to each server while the last option allows the user or manager to apply a maximum number of simultaneous connections to each database to similarly ensure that servers or databases do not become overloaded.

Hopefully, using the features discussed above, a manager or user will be able to effectively perform operations on databases within their networks. However, despite the best efforts of a manager, errors related to the forwarding of scripts to target databases may still occur. Examples of such occurrences include errors reported by databases or servers in response to a forwarded script, errors caused by changing network conditions (e.g., connection timeouts, network connectivity issues), etc.

When errors occur, the execution engines provided by the present invention may be operable to detect such errors and to respond in one or more ways as described below.

Generally, in accordance with one embodiment of the present invention, the execution engine unit 3 may be operable to stop the forwarding of one or more scripts in accordance with an error policy, once an error is detected.

For example, the present invention provides for the following optional error policies:
a. stop the forwarding of all scripts to all associated target databases and servers after an error occurs;
b. stop the forwarding of one or more scripts to each associated target database where the execution of a script causes an error, after the error is reported;
c. stop the forwarding of one or more scripts to each server that contains at least one associated target database where the execution of a script causes an error after such an error is reported;
d. stop the forwarding of a script that causes an error to all its associated target databases after an error is reported; and
e. Some combination of the error policy options described in (a)-(d).

Backtracking somewhat, we have spoken of scripts up until now as if each script was unrelated to another script. While this may be the case, it is also possible that one or more scripts are related to one another and in fact can be considered to make up a group of scripts. In accordance with further embodiments of the present invention, the error policies just discussed as well as other features discussed before and in the following paragraphs may be applied to a group of scripts as well as an individual script.

When considering the possibility that an error may occur before or after the forwarding of one or more scripts, the present invention provides a user or manager with the ability to minimize damage to a database or server. Accordingly, in yet a further embodiment of the present invention the execution engine unit 3 may be further operable to instruct each database in which a script error has occurred to roll back (i.e., reverse, undo) any changes that were made to that database by forwarded scripts up until the time that the error occurred. By so doing, any damage done to the database may be minimized.

In certain circumstances, a user or manager may wish to control the forwarding of scripts even further. Recall that in our earlier discussion we spoke about the forwarding of scripts in accordance with a particular order such as one script at a time, one database at a time or one server at a time. In this discussion it was assumed that once one process was completed (e.g., the forwarding of all scripts to one database) the next step in the process would follow immediately thereafter. In some cases, a user or manager may wish to pause a process for one reason or another. The present invention provides optional features that will allow this to occur.

In general, in accordance with still another embodiment of the present invention, the execution engine unit 3 may be further operable to pause the forwarding of one or more scripts based on a pause policy. More specifically, the pause policy may be selected from at least the group consisting of: pausing after the execution of a script on a server that contains target databases associated with the script; pausing after the execution of a script on each target database that is associated with the script; pausing after the execution of a script on all target databases that are associated with the script; pausing after an error related to the forwarding of a script is detected; and/or some combination of the pause policy options just mentioned. Again, a pause policy is equally applicable to a group of scripts. Once an execution engine pauses the forwarding of scripts, the execution engine informs a user or manager of the pause (e.g., through the display unit 5 or some other device or means that is accessible by a user), with details and messages concerning the reason for the pause (e.g., status messages, informational messages, warning messages, or error messages returned from databases or generated by an execution engine, etc.). Upon being informed the user or manager can instruct the execution engine to resume and continue to forward scripts, or alternatively to stop forwarding scripts. It should be understood that the examples just given are but a few examples of a pause policy and an error policy that may be provided by the present invention.

Though in many cases the format of a script in the code package unit 2 will be recognized and accepted by a target database without any warnings or errors, this again may not always be the case. For example, a script may be created using one format while a target database may be designed to recognize scripts formatted in accordance with a second format. When this occurs, there must be a method for conforming or converting a script to a format that is recognizable by a database. In accordance with an additional embodiment of the present invention, the execution engine unit 3 may yet be further operable to format one or more scripts, prior to forwarding such scripts, to match the format of one or more associated target databases. In this manner, once a script is forwarded there is some degree of assurance that the target database will be able to recognize and properly execute the script when it is received. Such formatting is sometimes referred to as pre-processing.

Many of the features of execution engines discussed above are configurable by a user or manager. Absent a user configuration, one or more of the options set forth above and below may be set as a default feature for an execution engine provided by the present invention.

In addition to giving a user the ability to configure execution engines, the present invention also provides a user with notifications, messages and the like during the operation of the execution engine.

In general, the execution engine unit 3 may be operable to forward a notification concerning the execution of one or more forwarded scripts, where such a notification may concern at least one of the following: an inability to establish or maintain a valid database connection, an execution error, a warning of some type, a specific message of some type and a message which is derived from a class of messages. All of these types of notifications, as well as others, may form all or part of a notification which is forwarded to a display or to some other device or means that is accessible by a user, which will inform the user of a status of one or more forwarded scripts. The format and/or means by which the notification is forwarded and/or received may take many forms, including: e-mail, text messages, facsimile and audio/audible (e.g. voice) messages to name just a few examples.

Nowadays there is a heightened concern about keeping networks secure. In accordance with a further embodiment of the present invention, either one or both of the execution engine unit 3 and/or code package unit 2 may be operable to generate a “secure script”. That is, the code package unit 2 may generate a code package that contains one or more secure scripts, or a secure script may be generated by the execution engine unit 3. By secure script is meant, for example, an encrypted/encoded script that can be viewed after proper authentication information (e.g., password and user name) is provided by a user or manager. In addition, the code package unit 2 may generate a “secure code package”. Such a secure code package, for example, may require a user or manager to submit proper authentication information prior to viewing the contents of the code package, or before the code package is passed to the execution engine unit 2, or before scripts in the secure code package are forwarded to one or more target databases by the execution engine unit 3. Furthermore, the execution engine unit 3 may be further operable to form a secure connection with an associated database or database server before forwarding one or more scripts.

In speaking of the ordering of scripts before, our discussion focused on a forwarding order. In yet additional embodiments of the present invention, the scripts may also be forwarded in accordance with a particular time period or schedule. That is to say, the execution engine unit 3 may be operable to forward one or more scripts in accordance with a schedule, where the schedule may be selected from the group consisting of at least: periodically, randomly, on-demand, and at specific dates and times. Said another way, one or more scripts may be forwarded periodically, randomly, on-demand, or at specified dates and times as configured by a user or manager.

It should be understood that one or more of the features of the present invention discussed above (and below) may be combined. For example, the ability to check whether a valid connection exists may be combined with a scheduling feature; both may also be combined with a notification feature. For example, in a further embodiment of the present invention the execution engine unit 3 may be operable to first verify that a valid connection can be established with each target database associated with one or more scripts prior to forwarding any of the scripts to the one or more associated target databases. This verification may proceed in accordance with a schedule. Thereafter, either during or after the verification process one or more notifications may be forwarded to a user (or a device that a user has access to) when a valid connection cannot be established. Here, again, the schedule governing the verification process may be selected from a periodic schedule, a randomly generated schedule, an on-demand schedule, or at specific dates and times, to give just a few examples of the types of scheduling which are possible and provided by the present invention.

We now turn our attention to the aggregation unit 4 presented in FIG. 1. As a reminder, the unit 4 may commonly (but not always) be combined with the execution engine unit 3 to form an application.

Once the execution engine unit 3 forwards a script to a database and the script is executed in that database, one or more ordered datasets may be returned to the execution engine unit 3. Received datasets/datatables may be transferred from the execution engine unit 3 to the aggregation unit 4. Each of the received datasets may comprise one or more ordered datatables. Upon receipt of the datasets/datatables the aggregation unit 4 may be operable to discover one or more column schemas within the received datatables, and identify column schemas that are common to one or more datatables. Thereafter, the aggregation unit 4 is operable to aggregate one or more datatables associated with each discovered common column schema in accordance with an aggregation order policy.

The present invention provides for many aggregation order policies. For example, an aggregation order policy may be selected from at least the group consisting of: aggregate datatables according to a received dataset order; aggregate datatables ignoring a dataset order; aggregate datatables according to a datatable order within each received dataset; aggregate datatables ignoring a datatable order within each dataset; aggregate datatables according to an order of columns within each column schema; and aggregate datatables ignoring an order of columns within each column schema; and/or some combination of the options just mentioned.

After datatables have been aggregated, the so aggregated datatables may be forwarded to a display so that they may be viewed, or be forwarded to a database or file for storage purposes. In accordance with the present invention this forwarding may occur in one of many different ways.

In one embodiment of the present invention, the aggregation unit 4 may be operable to forward aggregated datatables only after responses associated with all of the forwarded scripts have been received and aggregated. That is to say, in this first option, nothing is forwarded until all of the responses associated with all of the scripts have been aggregated, to ensure that all datatables that must be aggregated have indeed been returned from all databases.

In addition to forwarding aggregated datatables, the aggregation unit 4 may be operable to assign a display/storage label to each aggregated datatable. When aggregated datatables are forwarded from the aggregation unit 4, each datatable is forwarded together with its label. Labels passed (e.g., to a display unit, to a database, and/or to a file system) can be used to determine the display order of the aggregated datatables within the display, or can be used by a database and/or file system to mark the aggregated datatables stored (e.g., by including the label in a database table name and/or file name in a file system).

As one of ordinary skill might presume, this may require the controller 1 to reserve a large amount of memory in order to store the aggregated datatables until such time as all of the responses and all of the datatables have been aggregated.

Realizing this, the present invention provides for alternative methods for aggregating and forwarding aggregated datatables. Instead of waiting until all of the responses related to all of the forwarded scripts have been received and aggregated, the aggregation unit 4 may be further operable to forward datatables as they are aggregated.

More specifically, once the aggregation unit 4 discovers a column schema for each received datatable it assigns each discovered column schema a display/storage tag. For example, the first discovered column schema can be assigned the tag of one while the second discovered column schema can be assigned a tag of two. In such a manner each discovered column schema is assigned a specific display/storage tag which encapsulates the display order or storage mark (e.g., database table name, file name) of each datatable.

In addition, the datatables which contain a discovered column schema are also assigned a tag. In such a manner, each column schema and its related datatables are assigned a display/storage tag as they are discovered. Thereafter, when subsequent datasets and datatables are received, and the same column schema is discovered (i.e., a common column schema), the associated datatables are assigned the same display/storage tag (as the one assigned to the discovered common column schema) according to an aggregation order policy discussed above. Once a particular datatable has been assigned a tag, the aggregation unit 4 may be operable to forward the datatables with its assigned tag to a display or storage device (e.g., database, file, etc.). By so doing the forwarded datatables may be displayed and/or stored in an aggregated format.

It should be noted that the display unit 5 may be incorporated into the controller 1 or may be connected to the controller 1 for, among other things, displaying aggregated datatables in a format which is based on the assigned tags.

Having discussed features of execution engines and aggregation units provided by the present invention, we now present some examples of how these tools may be used by a manager or user and some more details of the present invention which may be insightful for those skilled in the database art.

Backtracking somewhat, once scripts containing database code are composed, the user of a tool embodying the principles of the present invention may combine all scripts into a single package. Once a package is constructed, the package can be saved in a single file (e.g., with the extension .cpa), and scripts within the package can be viewed and edited by the tool, as part of the package or as individual scripts.

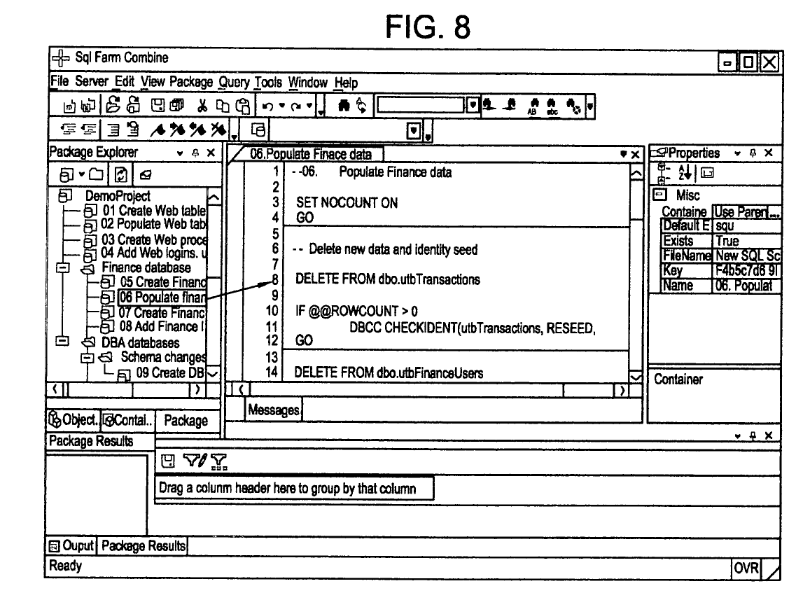

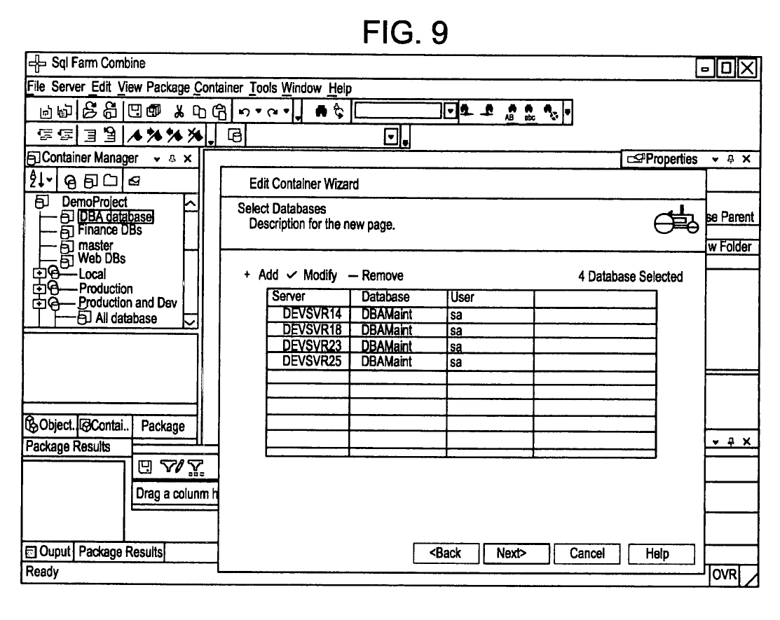

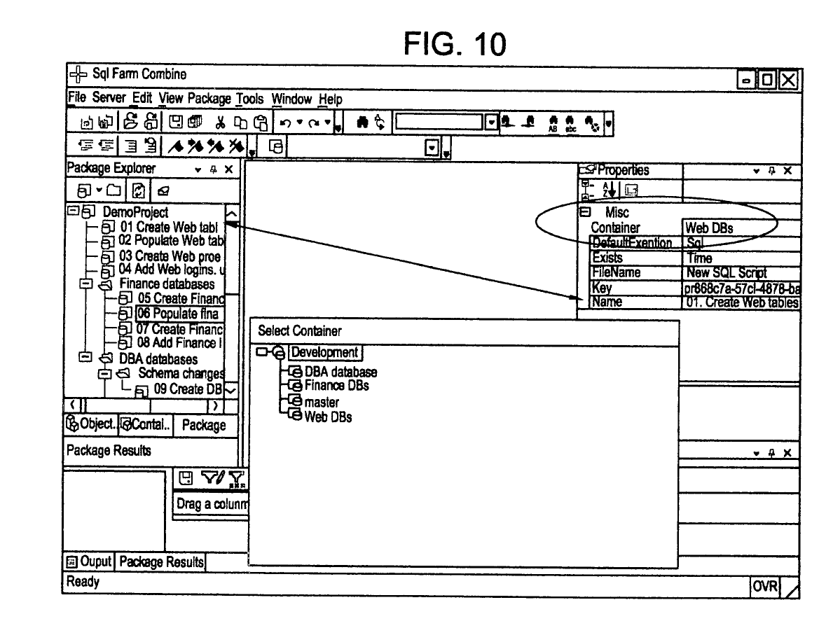

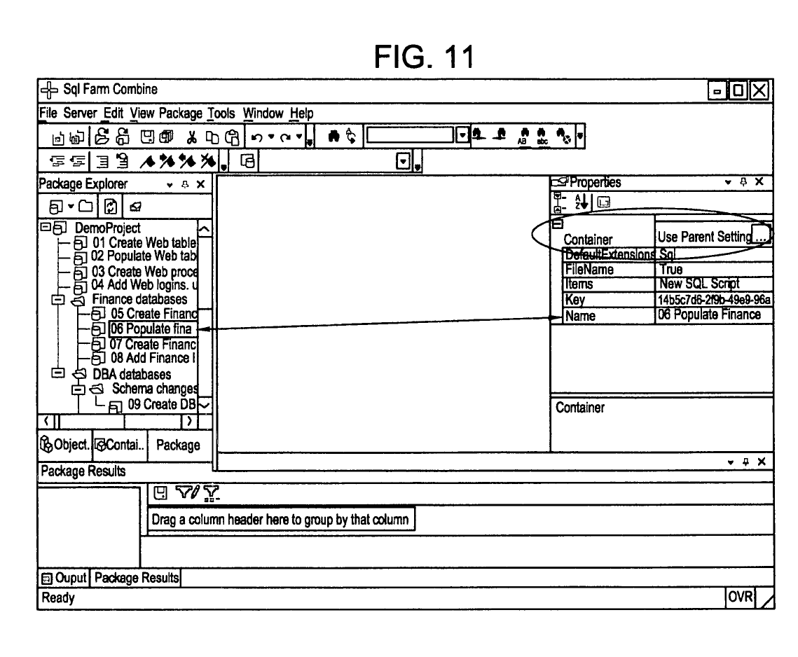

FIGS. 8-11 depict: exemplary images relating to the creation of a new code package (FIG. 8); the exemplary composition of a code package (FIG. 9); saving an exemplary code package in a .cpa file (FIG. 10); and viewing the contents of an exemplary script in a package (FIG. 11) in accordance with embodiments of the present invention.

Scripts may be composed and edited independently of whether they belong to a package. Once composed, a user can assign scripts to the package in several ways: (i) by associating a script from an editor window (as in FIG. 11) to a package; (ii) by opening an existing script file and placing it in the package; (iii) dragging and dropping a script from other application windows to the package; or (iv) by loading one or more files from a computer readable medium to a package (e.g., entire folders or selected files from a hard drive). FIG. 9 shows some of the options available for loading a script into a package.

Once a code package is ready, it can be saved as a .cpa file (see FIG. 10). This file can later be opened by any user that has access to the .cpa file. The code package and scripts can be viewed, edited, and saved either as individual scripts, or as an update to the package. To view the package and its contents, all a user needs to do is to double-click the .cpa file, or alternatively, open the application and .cpa file from within the application window. Furthermore, a user who builds the package may choose to encrypt scripts placed in the package. Scripts may be encrypted individually (i.e., some scripts can be encrypted while others may not be encrypted), and each encrypted script may later be viewed only if the correct authentication information is provided by a user who attempts to read the script.

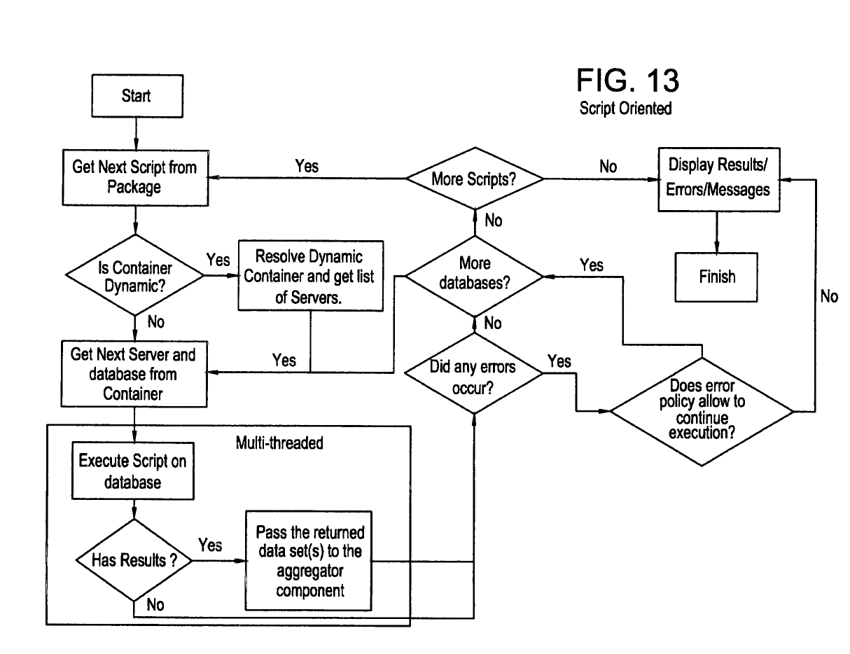

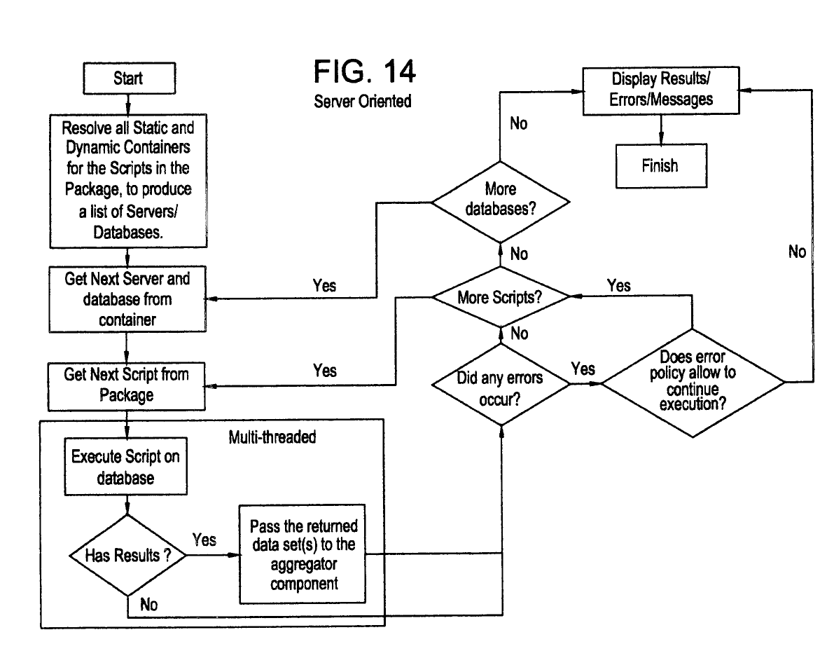

To help users organize code packages, a code package may consist of several objects, namely a root node (see element 1301 in FIG. 13), folders (see element 1302 in FIG. 13) and any number/levels of subfolders (see element 1303 in FIG. 13) (folders and subfolders are optional), and scripts (see element 1304 in FIG. 10). The user can assign a script to a folder, subfolder, or to the root node directly. FIGS. 13 and 14 depict examples of script organization in accordance with embodiments of the present invention.

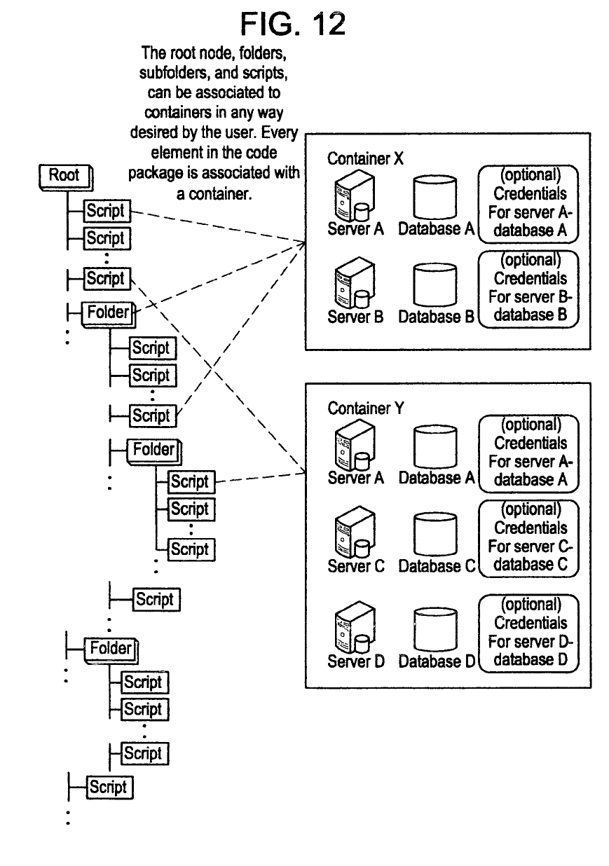

Tools provided by the present invention allow users to pre-configure any number of Containers. A Container holds identifiers of one or more databases. For example, in FIG. 12 the content of a Container named “DBA databases” 1202 is shown. This Container 1202 consists of identifiers of 4 different databases 1203 named “DBAMaint” (FIG. 12 depicts a special case where all database names are identical, which is not the case in general), on four different servers, namely DEVSVR14, DEVSVR18, DEVSVR23, and DEVSVR25. Furthermore, this example illustrates a special case where each database identifier in the Container consists of a database name, its database server name, a user name and password (the password is not shown in FIG. 12).

The definitions and configuration parameters for all Containers can be stored in several ways: as a plain text file on disk/drive in some predetermined format (e.g., XML), in a registry, within a database table that is read/queried by the tool, or by using any other storage technique. Furthermore, Container configurations can be saved as clear text, or can be hashed (i.e., encrypted).

Referring back to the example in FIG. 13, a user can associate a single Container with each script, from the list of pre-configured Containers 1306, as exemplified in FIG. 13 for a Container named “Web DBs” 1305. Containers can be either associated directly with each script as in the association 1307, or a script can inherit the Container associated with their parent entity (i.e., a folder, subfolder, or root node). Similarly, subfolders can inherit the Container associated with their parent folders, and if folders are placed immediately under the root node, they can inherit the Container defined for the root. The concept of Container inheritance is illustrated in FIG. 14.

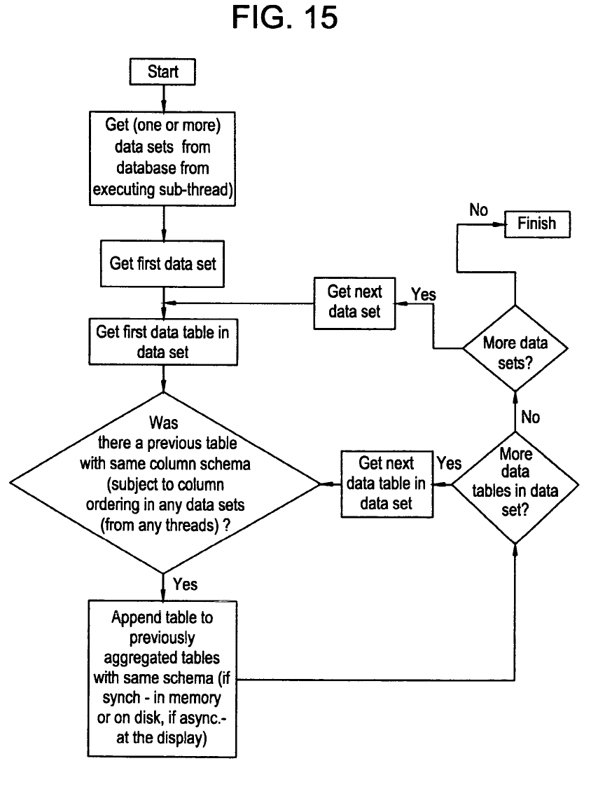

After all scripts may have been assigned to Containers, the resulting package may be saved. Thereafter, the package is ready for deployment (i.e., to be passed to an execution engine in order to forward scripts to databases). FIG. 15 summarizes the components of exemplary packages.

The ordering options (e.g., one script at a time, etc.) discussed before can be set at a node level (i.e., root node, folder, subfolder level; but not script level). In nodal terminology, these options include:
a) scripts, under each node, may be forwarded one script at a time;
b) scripts, under each node, may be forwarded to one server at a time; and
c) scripts, under each node, may be forwarded to one database at a time.

These options may be set at the node level and each node can inherit the configuration settings of its parent node. However, because these options are not available at the individual script level, all scripts under each node will be forwarded in accordance with the option associated with their immediate parent node. If no options are set for any node, then default configuration options which can be configured by a user or manager will be set for the nodes in the package. In the absence of default code package configuration, then default configuration which can be configured by a user or manager in the execution engine will be set for the nodes in the package.

Take the package in FIG. 15 as an example. All scripts 1502 before the first folder 1501 will be executed first, according to the options associated with the root node 1507. Then, all scripts 1503 within the first folder 1501 (up to the subfolder 1504) will be executed next, based on the options associated with the folder 1501. Then all scripts 1505 in the subfolder 1504 are executed followed by the remaining scripts 1506 in the folder, and so on.

Before presenting some examples of how scripts may be forwarded substantially simultaneously (referred to sometimes as “multi-threading”), it should be noted that in accordance with the present invention the connection to, and forwarding/execution of, scripts against a database of a given server type (e.g., MS-SQL) is done in a more generic manner than other existing techniques.

In the present invention, a connection to a database or server is established by using server-type specific communication drivers. Script execution is then performed by forwarding/executing the contents of the script to a target database. In other words, execution engines provided by the present invention can be used to forward scripts to databases and servers of any type.

Execution engines provided by the present invention may invoke multiple sub-threads (e.g., connections, database accesses). The nomenclature “threads”, “sub-threads”, etc. may be more familiar to those skilled in the art. Each sub-thread includes a script to be forwarded and a database identifier associated with the script, and multiple sub-threads can operate simultaneously, or substantially simultaneously.

Several techniques of launching additional sub-threads are provided by the present invention. For example, a user may configure a package to use one of the following methods:

1. Thread pooling: An execution engine sends a request to a “black-box” component (known as the “thread pool”), that belongs to an operating system to initiate a new thread. Then, the thread pool will hand the assigned thread to the execution engine. Using this option, connection parameters (e.g., persistent vs. non-persistent, reuse of threads or database connections) are completely handled by the thread pool.

2. Active threading: An execution engine is responsible for creating each sub-thread and later closing each sub-thread. Here, the reuse of threads or connections to databases must also be explicitly handled by the execution engine.

Given a code package and all configuration parameters, an execution engine may resolve each Container (e.g., detect the identifiers of all target databases in the Container), for each script in the package. This may be the case when database identifiers are specified as part of a Container (as in example 1203 in FIG. 12), or when identifiers in a Container are stored in some other data sources (e.g., databases, files, registries, etc.), as depicted in FIG. 6. When identifiers in a Container are stored in data sources and not explicitly specified as part of a Container, we refer to this type of a Container as a “Dynamic Container”. If a Dynamic Container is used, the execution engine may be configured to retrieve identifiers of all target databases in a Dynamic Container before forwarding any script in the code package, or prior to forwarding each script or group of scripts that is associated with a Dynamic Container. Alternatively, this configuration option can be set by a code package unit and then be passed to the execution engine. In addition, if a tool provided by the present invention is configured to use a Dynamic Container, once all database identifiers of Container databases are retrieved from a data source, the execution engine may operate multiple sub-threads to perform connectivity verification or carry out an authentication process with each database substantially simultaneously to ensure proper connectivity, and/or forward scripts to target databases associated with each script, substantially simultaneously.

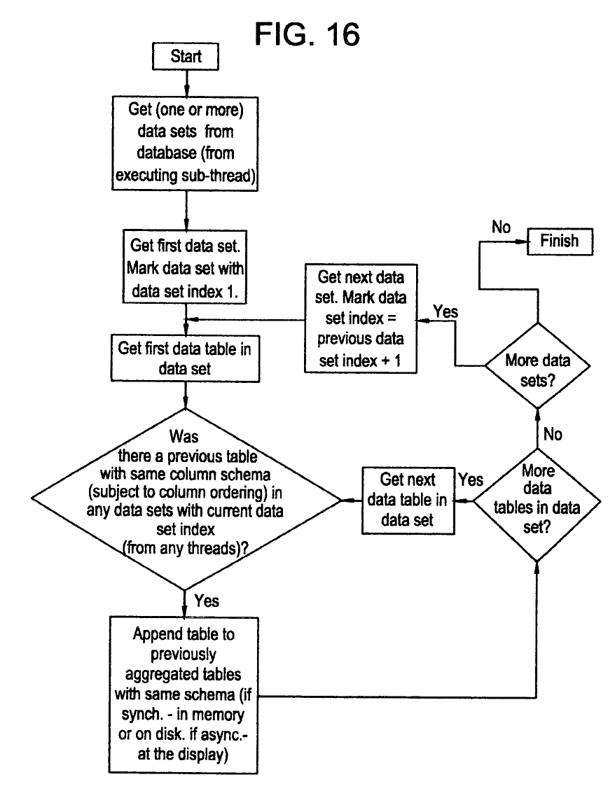

The concept of Dynamic Containers is illustrated in FIG. 16. In this figure, a script is associated with a group of target databases, and identifiers of target databases in the group are retrieved by the execution engine (although they can also be retrieved by the code package) as follows. Once the execution engine receives the code package, it runs a reference query 1601 against all reference data sources defined in the Reference 1602. In this example, the data sources are database DB A on database server DataSource1 and database DB B on database server DataSource2 (i.e., the Reference 1602 maps to the identifiers 1603, although this mapping is not shown in FIG. 16). Then, identifiers are received in response to forwarding/executing the reference query against these data sources, and the script 1604 (named “Create Web Tables” in FIG. 16) is executed against all target databases identified by the received identifiers. In addition, it should be understood that script forwarding may be performed according to a forwarding order as well as other options set forth above and below.

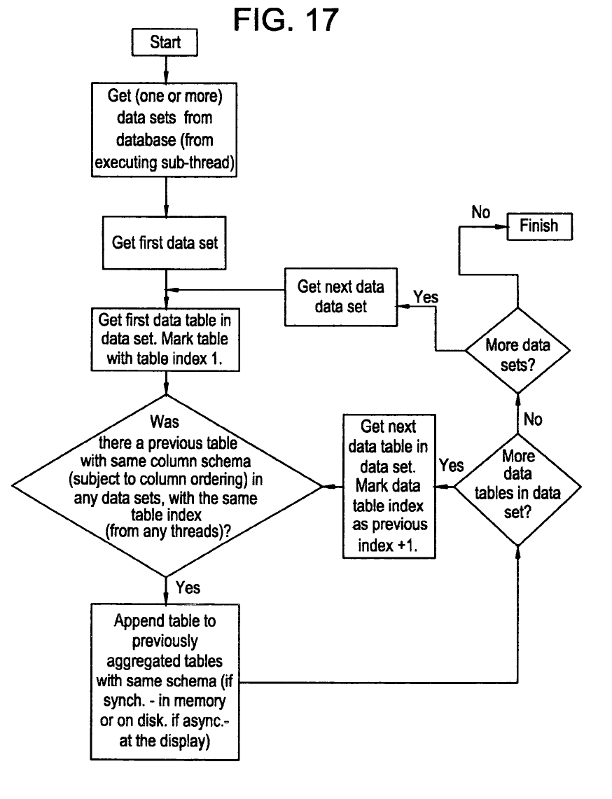

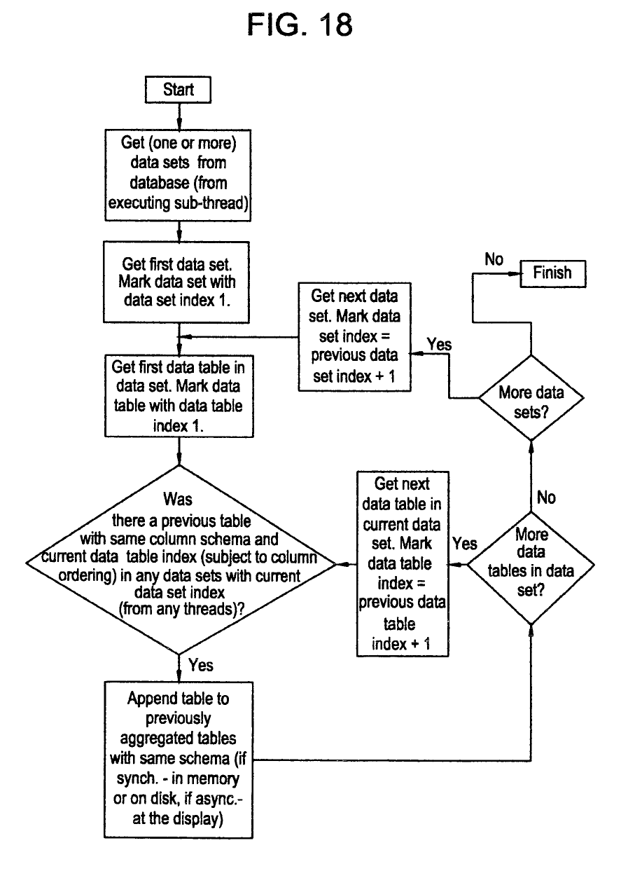

At this point, we present some examples of the execution of a code package in accordance with embodiments of the present invention. FIG. 17 depicts one process which may be used to execute all scripts in a code package in accordance with one embodiment of the present invention. FIG. 17 shows parallel execution employed by a package node (and its child of scripts). Using one option, each script is first executed on all of its target databases before moving to the next script. Moreover, in FIG. 17, an execution engine resolves Dynamic Containers during script execution. Alternatively, the resolution can be performed once the execution engine is invoked, before any scripts are executed. While FIG. 17 depicts a one script at a time execution, FIG. 18 depicts a one database at a time execution. Furthermore, in FIG. 18, an execution engine resolves Dynamic Containers before any scripts are forwarded.

As mentioned before, an aggregation unit 4 is responsible for the aggregation of datatables in datasets returned from target databases. In one embodiment of the invention, the aggregation unit 4 may operate using the “common column schema” feature where only datatables with the same set of columns may be aggregated. For example, if one datatable has the columns (Col1, Col2), and another datatable has the columns (Col1, Col2) as well, these datatables can be aggregated. Furthermore, if a third datatable has the columns (Col2, Col1), then this datatable may also be aggregated to the previous datatables (based on the aggregation order policy configuration described above and below). However, if a fourth datatable has the columns (Col1, Col2, Col3), the content (e.g., rows) of this datatable cannot be aggregated with the contents of the datatables above because the set of columns is not identical to those of the datatables above.

The aggregation unit 4 supports several modes of operation, which can be set either at a code package unit 2, an execution engine unit 3, or directly at the aggregation unit 4. A user may select a desired aggregation order policy prior to package execution in the code package. In addition, the user can configure an aggregation output policy. If the user does not select either one or both of mentioned policies, then the aggregation unit 4 operates under default configuration settings (which can also be set by a user). The aggregation order policy and aggregation output policy are explained above and now below.

An aggregation order policy determines how datatables in received datasets may be aggregated. The options available include:

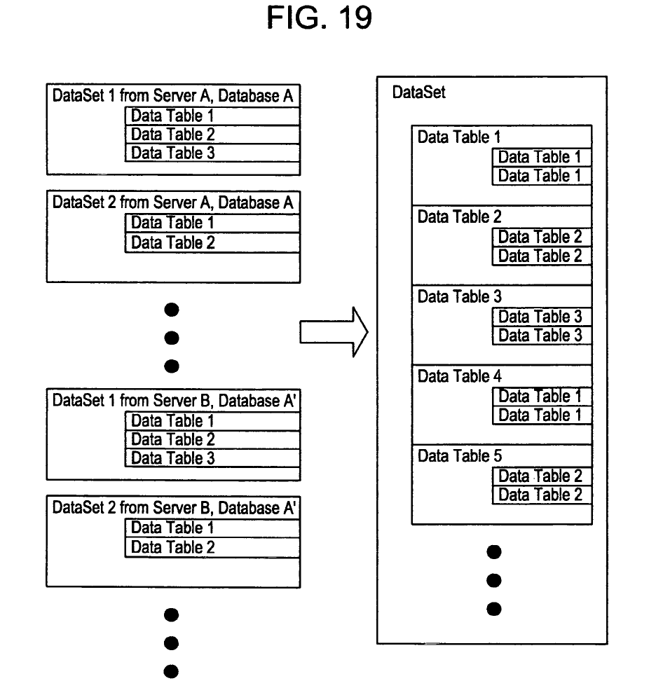

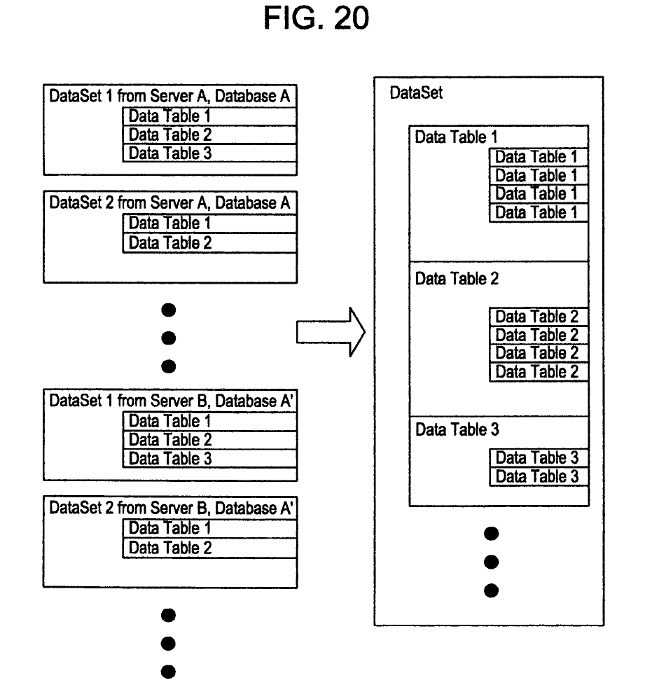

1. “Column order matters”—if this option is set, then only datatables that have the same column schema (e.g., column names and order) may be aggregated. Following the example above, the rows in a datatable with columns (Col1, Col2) may only be aggregated with other datatables that have the same (Col1, Col2) columns. Therefore, a datatable with columns (Col2, Col1), for example, cannot be aggregated with the previous datatables. This option is also illustrated in FIG. 19, which depicts a scenario where the Column order matters option is set. In this example, a single dataset that contains two datatables is returned from each one of Database X and Database Y (this is a special case where the number of datatables in each datasets is the same, which is not the case in general). The datatable marked as datatable 1 (see 1901 in FIG. 19) has a column schema (Column1, Column2, Column3) 1902, and datatable 2 (see 1903 in FIG. 19) has a column schema (Column3, Column1, Column2) 1904. Therefore, the two datatables are not aggregated. However, when the Column order matters option is turned off, the two datatables can be aggregated, as depicted in block 2001 in FIG. 20.

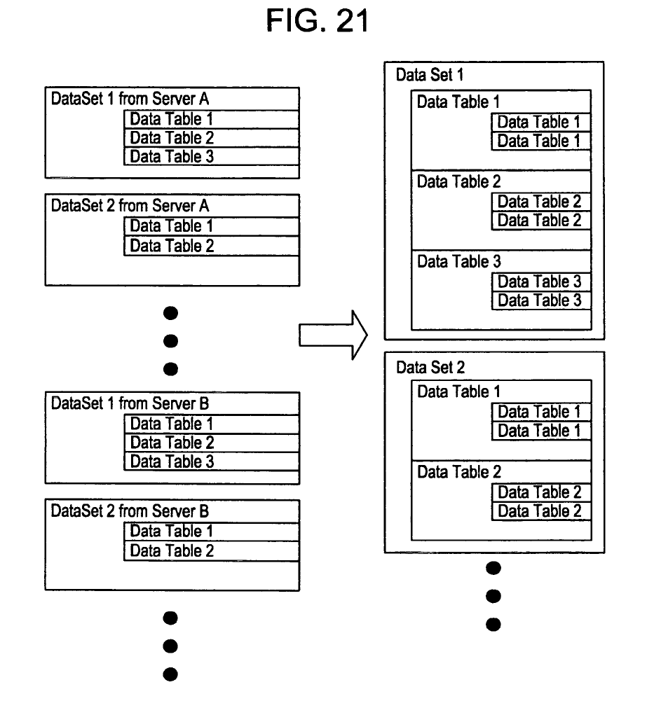

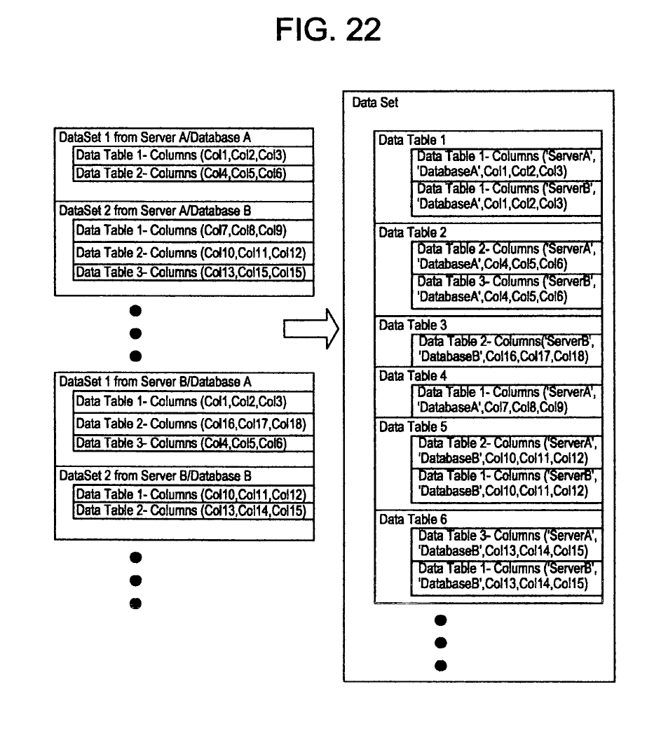

2. “Datatable order matters”—Recall that each script may return multiple datasets and that several datatables can belong to each dataset. If this option is selected, then only datatables that are the n'th datatables in the dataset may be aggregated, for some value of n. In other words, if: (i) a datatable has columns (Col1, Col2), and this is the n'th datatable in a dataset; (ii) another received datatable with the same column schema is returned from another database and is the m'th datatable in the data set; and (iii) if m and n are not equal, then the two datatables will not be aggregated. It should be understood that aggregation is also subject to option 1 (i.e., the Column order matters option). An example of the Datatable order matters is provided in FIG. 21 and FIG. 22. Referring to FIG. 21, the Datatable order matters option is not set, therefore datatable 1 which is the first datatable in dataset 1 returned from database X (denoted by 2101) and datatable 1 which is the second datatable in dataset 1 returned from database Y (denoted as 2102) are aggregated as indicated in block 2103, although they do not have the same order within each received dataset. On the other hand, FIG. 22 exemplifies the case where the Datatable order matters option is set, whereby the datatables 2201 and 2202 (with the same column schema 2203) in the two received datasets are not aggregated.

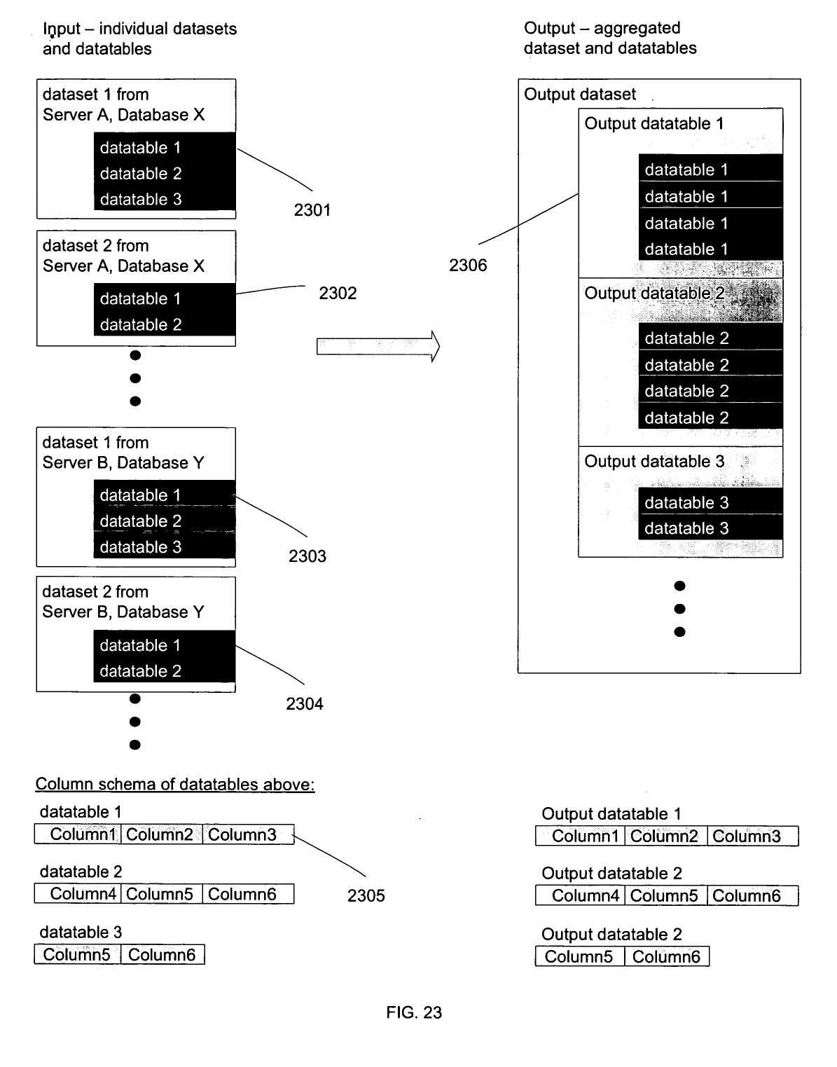

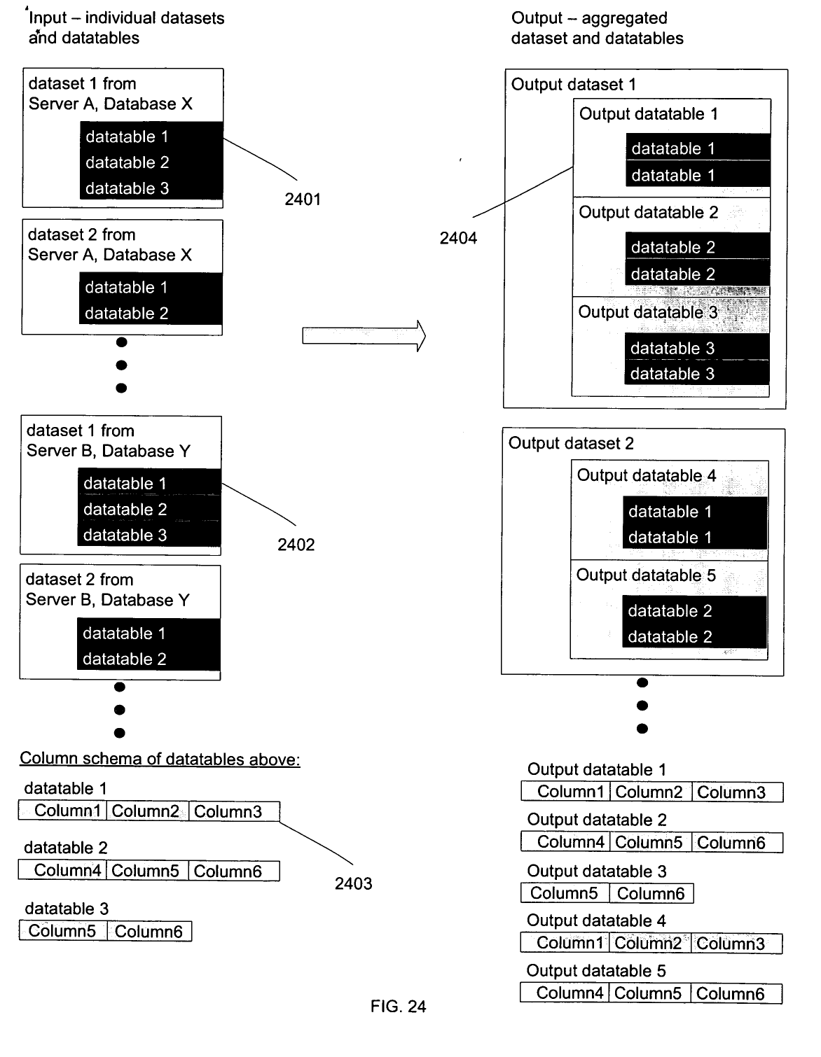

3. “Order of dataset matters”—With this option, datatables may be aggregated if an only if they belong to the n'th dataset, for some value of n, subject to the setting of option 1 and option 2 above. In other words, if one datatable belongs to the n'th dataset returned from one database, and another datatable belongs to the m'th dataset returned from another database, and the two datatables have the same column schema, then the two datatables may not be aggregated unless m and n are equal. This option is illustrated in FIG. 23 and FIG. 24. In FIG. 23, the Order of dataset matters option is not set, therefore datatable 2301 marked as datatable 1 in dataset 1 from database X is aggregated with datatable 1 in dataset 2 from database X (see block 2302 in FIG. 23) and datatable 1 in dataset 2 from database Y, and so forth and so on. The aggregated datatable is shown in block 2306. However, when the Order of dataset matters option is set as in the example presented in FIG. 24, then datatable 1 in dataset 1 from database X (denoted as 2401) is aggregated with datatable 1 in dataset 1 from database Y (denoted by 2402) to produce the aggregated datatable 2404, but not with datatabale 1 in dataset 2, from either database X or Y.

A further example of option 3 is as follows. Suppose a script contains a statement separating two subscripts (e.g., a “GO” statement used by a server-type known as MS-SQL). In existing tools, both subscripts are forwarded. Assuming a database which receives such subscripts can execute them, the responses which are returned typically make up either a single dataset for each subscript with multiple datatables or no datasets at all. When a single dataset is returned, it may be difficult for a user to determine which datatables correspond to which subscript.

To overcome this difficulty, the present invention provides execution engines that are operable to forward each subscript (e.g., the one before the “GO” statement followed by the one after the “GO” statement) separately. Because the subscripts are forwarded separately, separate responses and/or datasets, one for each subscript, are returned from a target database. The separate responses can more easily be associated with their original subscript by a user.

Aggregation units provided by the present invention may incorporate aggregation output policies to determine when/how aggregated results are output from the aggregation unit 4 for display or storage purposes. Examples of such aggregation output policies are as follows.

“Synchronous output policy”—In this mode, the aggregation unit 4 aggregates all datatables based on an aggregation order policy (discussed beforehand). Only when all of the returned datatables associated with every script have been aggregated are the so-aggregated datatables passed (e.g., to a display unit or a storage device) for display or storage purposes.

“Script-level synchronous output policy”—In this mode, the aggregation unit 4 aggregates data returned from each database after each script is executed. After aggregating datatables for each single script, the aggregation unit 4 then outputs the aggregated results. In this way, a user need not wait until aggregation is completed for all scripts. The results may be displayed (or stored) for each script (i.e., a script-at-a-time), while other scripts are still being executed, and datatables returned in response to the execution of those other scripts may still be undergoing aggregation.

“Asynchronous output policy”—In this mode, the aggregation unit 4 passes datatables as responses are still arriving from databases. Once a first datatable is returned, it is forwarded for display or storage purposes, together with a tag. Thereafter, when another datatable arrives to the aggregation unit 4 and needs to be aggregated with an already-passed datatable (according to an aggregation order policy), the datatable is assigned the same tag used for the previously passed datatable to be aggregated. Then, once a datatable is passed to a display unit or a storage device (e.g., database, file, etc.), it is appended to previously passed datatables with the same tag (if such exist) by the display unit or in the storage device. If none of the previously passed datatables have the same tag, then the content of the datatable is displayed or stored without being aggregated. In this mode of operation, results are displayed or stored as they are returned from the databases, and are aggregated while being displayed/stored.

At this point it should be noted that in yet another embodiment of the present invention, each script or a group of one or more scripts in a code package can be associated with an aggregation output policy. Using this feature, datatables returned in response to the forwarding/execution of some scripts may be aggregated using one aggregation output policy option, while aggregation of datatables returned in response to the forwarding/execution of other scripts may be aggregated using a different option. Furthermore, the aggregation output policy can be configured in the code package unit 2 and then received by the aggregation unit 4. If the aggregation order policy is not provided in a code package, then default settings in the aggregation unit 4 are used.

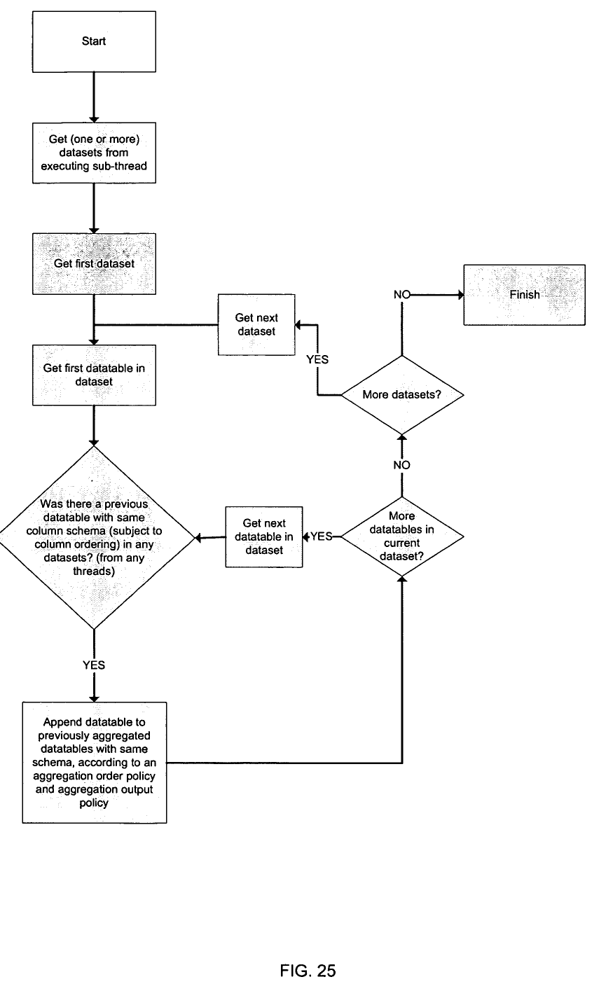

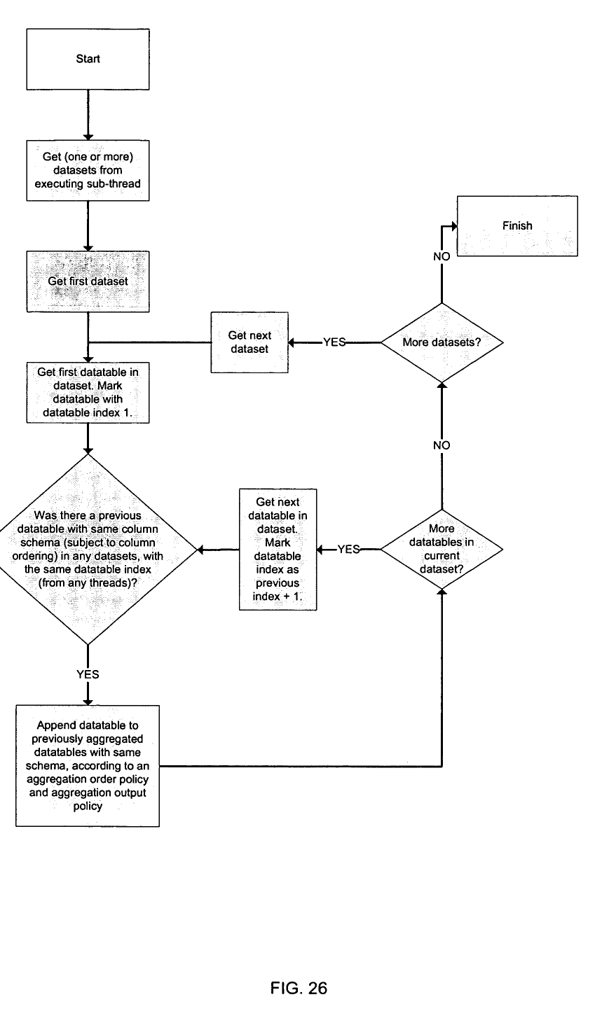

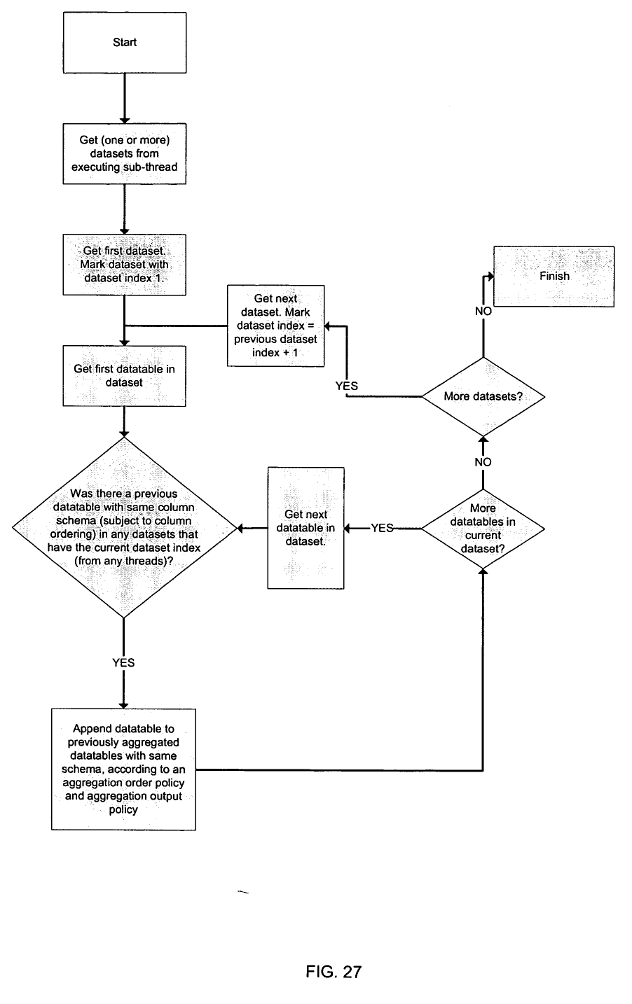

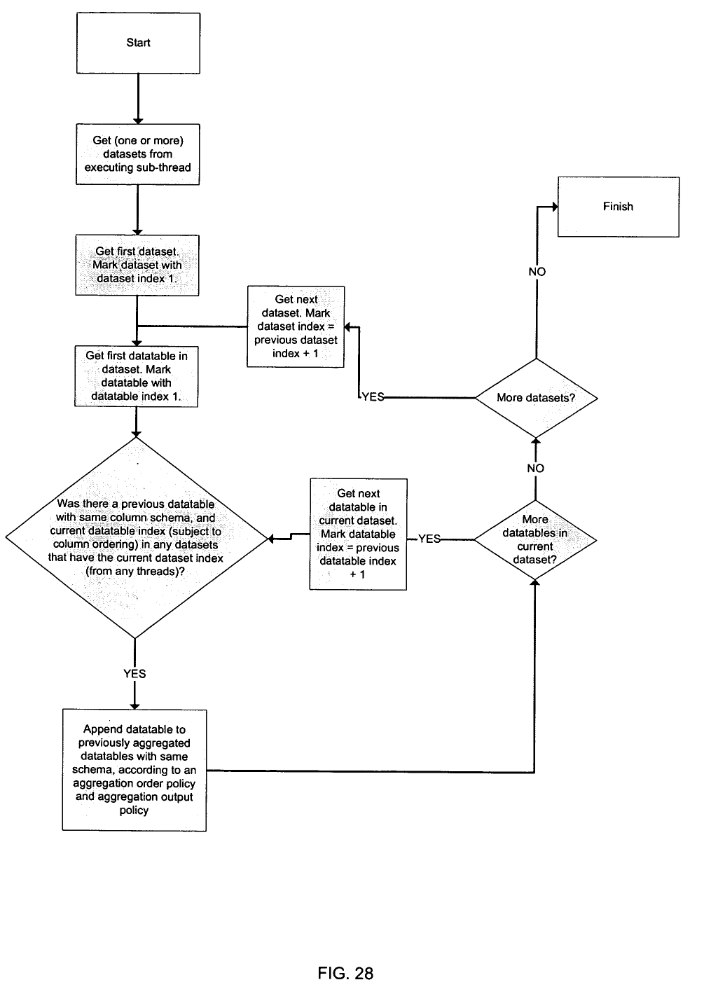

Operational diagrams depicting various aggregation methodologies provided by embodiments of the present invention are shown in FIGS. 25-28, for various aggregation order policies. It should be noted that when large datatables (i.e., ones with a high data volume, large amount of rows) are returned from a database, it is possible that memory-based aggregation will not work properly. For this reason, the present invention provides for disk-aggregation (i.e., in a database and/or a file). When a file is used, a pre-determined file format (e.g., XML) should be used to append the newly aggregated datatables. Though memory or disk-aggregation can be selected by a user, they may also be selected by an execution engine or an aggregation unit. Either option can be activated as a default feature. Alternatively, the execution engine or aggregation unit may initially be set to memory-aggregation, but upon detecting a large number of rows in a datatable (e.g., upon crossing a “row threshold”) switch to disk-aggregation or vice versa.

The output of aggregation unit 4 may be one or more aggregated datatables. These aggregated datatables may all belong to a single dataset, or several datasets. For example, a user can create a single dataset for each aggregation, so that each aggregated datatable is the only member in its dataset.

Furthermore, if a user configures tools provided by the present invention to do so, additional columns can be added by the execution engine unit 3 or the aggregation unit 4 to each row in every datatable. These columns include the server name and database name from which a datatable (and thus rows) was returned, and/or the timestamp at which each datatable was returned.

The above discussion has set forth some examples of the present invention. However, the scope of the present invention is more fairly determined by the claims which follow.

### APPENDIX

Exemplary Definitions

Code package: Includes one or more scripts, each script associated with one or more database identifiers that reflect targets of script forwarding.

Column schema: An ordered set of columns (e.g., column names, column identifiers).

Connection timeout: A maximum amount of time to establish a valid connection with a database.

Container: A group of identifiers of one or more databases.

Dataset: An entity comprising one or more datatables, and possibly additional attributes.

Datatable: An entity comprising columns, rows of data, and possibly additional attributes.

Error: Includes at least:

(a) the inability to establish or maintain a valid connection;
(b) the reception of responses that indicate an invalid operation in response to the execution of a script on a database; and
(c) exceeding a connection timeout or script execution timeout.
   Execution timeout: A maximum amount of time for a database to execute a forwarded script.
   Identifier: A set of values that can be used to identify and establish a connection to a database. For example, a collection consisting of a database name, and a name/address of the database server that contains the database can be used as an identifier. This collection may also include one or more of the group consisting of at least: a communication port and/or protocol to a database server, a connection timeout, an authentication type and/or mode, a user name, and a password.
   Reference query: A type of script in a code package that is used to return identifiers of databases from various data sources (e.g., databases).
   Script: A combination of any number of commands that can be executed on a database (e.g., table execution statement, queries, procedures, functions, execution demands, etc.).
   Script forwarding: The operation of connecting to a database (by either using existing connections, if such exist, or initiating a new connection), passing a script to the database, and directing the database to execute passed script.
   Valid connection: A connection with a database that is established using authentication information subject to a connection timeout, and can be used to communicate with the database.
   Warning message: A type of message from a database or database server.

We claim:

1. A computer readable medium comprising an execution engine operable to:
receive a code package that includes one or more scripts and one or more database identifiers, wherein each script is associated with one or more of the identifiers; and
forward one or more scripts, to one or more target databases substantially simultaneously, each target database being identified by the identifiers that are associated with each script.

2. The computer readable medium as in claim 1 wherein the execution engine is further operable to forward the one or more scripts in accordance with a forwarding order.

3. The computer readable medium as in claim 2 wherein the forwarding order comprises:
a) forwarding a same script, in accordance with a script order, to each of its associated target databases substantially simultaneously before a next script in the order is forwarded; and
b) repeating the process in (a) for each next script in the order.

4. The computer readable medium as in claim 2 wherein the forwarding order comprises:
a) forwarding each script in accordance with a script order, to a same associated target database that is selected in accordance with a target database order before any scripts are forwarded to a next associated target database; and
b) repeating the process in (a) for each next associated target database in the target database order.

5. The computer readable medium as in claim 2 wherein the forwarding order comprises:
a) forwarding each script in accordance with a script order to one or more associated target databases on a same database server substantially simultaneously, the database server being selected in accordance with an order of servers that contain one or more of the associated target databases, before any script is forwarded to an associated target database that resides on a next database server; and
b) repeating the process in (a) for each next database server in the server order.

6. The computer readable medium as in claim 2 wherein the forwarding order may be included in the code package or determined by the execution engine.

7. The computer readable medium as in claim 1 wherein the execution engine is further operable to verify that a valid connection can be established with each target database associated with the one or more scripts substantially simultaneously prior to forwarding any of the scripts to one or more of the associated target databases.

8. The computer readable medium as in claim 1 wherein the execution engine is further operable to forward one or more scripts to one or more associated target databases in accordance with a connection limit, wherein the connection limit is selected from at least the group consisting of: a maximum number of simultaneous connections to all databases and database servers, a maximum number of simultaneous connections to each database server, and a maximum number of simultaneous connections to each database.

9. The computer readable medium as in claim 1 wherein the execution engine is further operable to forward one or more reference queries in the code package to one or more databases, indicated by database identifiers as being associated with a reference query to be forwarded, substantially simultaneously prior to forwarding one or more of the scripts.

10. The computer readable medium as in claim 9 wherein the execution engine is further operable to:
receive identifiers in response to a forwarded reference query; and
forward one or more scripts to target databases identified by the received identifiers as being associated with each script substantially simultaneously.

11. The computer readable medium as in claim 1 wherein the execution engine is further operable to maintain a valid connection to each target database associated with a script after the script is forwarded for a duration indicated by an execution timeout associated with the script.

12. The computer readable medium as in claim 1 wherein the execution engine is further operable to forward the one or more scripts in accordance with an error policy.

13. The computer readable medium as in claim 12 wherein the error policy is selected from at least the group consisting of:
a) stop the forwarding of all scripts to all associated target databases and servers after an error occurs;
b) stop the forwarding of all scripts to each associated target database where the execution of a script causes an error after the error occurs;
c) stop the forwarding of all scripts to a database server that contains at least one associated target database where the execution of a script causes an error after the error occurs;
d) stop the forwarding of all scripts in a group of one or more scripts to all associated target databases after an error occurs;
e) stop the forwarding of all scripts in a group of one or more scripts to each associated target database where the execution of a script causes an error after the error occurs;
f) stop the forwarding of all scripts in a group of one or more scripts to a server that contains at least one associated target database where the execution of a script causes an error after the error occurs; and
g) some combination of the policies (a)-(f).

14. The computer readable medium as in claim 12 wherein the execution engine is further operable to instruct each database associated with an error to roll back any changes that were made to that database in response to forwarded scripts up until the time that the error occurred.

15. The computer readable medium as in claim 1 wherein the execution engine is further operable to forward the one or more scripts in accordance with a pause policy.

16. The computer readable medium as in claim 15 wherein the pause policy is selected from the group consisting of at least:
a) pausing after the execution of a script on each server that contains associated target databases;
b) pausing after the execution of a script on each associated target database;
c) pausing after the execution of a script on all associated target databases;
d) pausing after the execution of one or more scripts from a group of scripts on each server that contains associated target databases;
e) pausing after the execution of one or more scripts from a group of scripts on each associated target database;
f) pausing after the execution of one or more scripts from a group of scripts on all associated target databases;
g) pausing after an error occurs in response to the execution of one or more scripts; and
h) some combination of the policies (a)-(g).

17. The computer readable medium as in claim 1 wherein the execution engine is further operable to format one or more scripts, prior to forwarding said scripts, to match the format of a database server that contains an associated target database.

18. The computer readable medium as in claim 1 wherein the execution engine is further operable to send a notification concerning the forwarding of one or more scripts, wherein the notification concerns at least one of the group consisting of: an inability to establish or maintain a connection to an associated database or database server, a connection timeout, an execution timeout, an execution error, a warning, a specific message and a message from a class of messages.

19. The computer readable medium as in claim 18 wherein notifications may be sent by one or more of the group consisting of at least: email, text message, facsimile, voice, and an audible signal.

20. The computer readable medium as in claim 1 wherein the execution engine is further operable to forward one or more scripts in accordance with a schedule.

21. The computer readable medium as in claim 20 wherein the schedule may be selected from at least the group consisting of: periodically, randomly, on-demand, and at specified dates and times.

22. The computer readable medium as in claim 1 wherein the execution engine is further operable to generate a secure script.

23. The computer readable medium as in claim 1 wherein the execution engine is further operable to form a secure connection with an associated database or server before forwarding one or more of the scripts.

24. A computer readable medium comprising an aggregation unit operable to:
receive one or more ordered datasets in response to a forwarded script from one or more associated target databases, wherein each dataset comprises one or more ordered datatables;
discover a column schema associated with each received datatable;
discover one or more common column schemas within the received datatables; and
aggregate one or more datatables associated with each common column schema in accordance with an aggregation order policy.

25. The computer readable medium as in claim 24 wherein the aggregation order policy may be selected from at least the group consisting of:
a) aggregate datatables according to a received dataset order;
b) aggregate datatables ignoring a dataset order;
c) aggregate datatables according to a datatable order within each received dataset;
d) aggregate datatables ignoring a datatable order within each dataset;
e) aggregate datatables according to an order of columns within each column schema;
f) aggregate datatables ignoring an order of columns within each column schema; and
g) some combination of the policies (a)-(f).

26. The computer readable medium as in claim 24 further operable to output the aggregated datatables once responses associated with one or more of the scripts have been aggregated along with a label.

27. A computer readable medium comprising an aggregation unit operable to:
receive one or more ordered datasets in response to a forwarded script, wherein each dataset comprises one or more datatables;
discover an ordered column schema associated with each received datatable;
assign each ordered column schema to a tag;
assign each datatable a tag that corresponds to its column schema tag according to an aggregation order policy;
output the datatables with the assigned tag in order to display or store the datatables in an aggregated format.

28. The computer readable medium as in claim 27 wherein the aggregation order policy may be selected from at least the group consisting of:
a) aggregate datatables according to a received dataset order;
b) aggregate datatables ignoring a dataset order;
c) aggregate datatables according to a datatable order within each received dataset;
d) aggregate datatables ignoring a datatable order within each dataset;
e) aggregate datatables according to an order of columns within each column schema;
f) aggregate datatables ignoring an order of columns within each column schema; and
g) some combination of the policies (a)-(f).

29. A computer readable medium comprising an execution engine operable to:
receive a code package that includes one or more scripts and one or more database identifiers, wherein each script is associated with one or more of the identifiers, and
forward one or more scripts, to one or more target databases substantially simultaneously, each target database being identified by the identifiers that are associated with each script; and
an aggregation unit operable to:
receive one or more ordered datasets in response to a forwarded script from one or more associated target databases, wherein each dataset comprises one or more ordered datatables;
discover a column schema associated with each received datatable;
discover one or more common column schemas within the received datatables; and
aggregate one or more datatables associated with each common column schema in accordance with an aggregation order policy.

30. A method for simultaneously accessing multiple databases comprising:
receiving a code package that includes one or more scripts and one or more database identifiers, wherein each script is associated with one or more of the identifiers; and
forwarding one or more scripts, to one or more target databases substantially simultaneously, each target database being identified by the identifiers that are associated with each script.

31. The method as in claim 30 further comprising forwarding the one or more scripts in accordance with a forwarding order.

32. The method as in claim 31 further comprising:
a) forwarding a same script, in accordance with a script order, to each of its associated target databases substantially simultaneously before a next script in the order is forwarded; and
b) repeating the process in (a) for each next script in the order.

33. The method as in claim 31 further comprising:
a) forwarding each script in accordance with a script order, to a same associated target database that is selected in accordance with an associated, target database order before any scripts are forwarded to a next associated, target database; and
b) repeating the process in (a) for each next associated, target database in the order.

34. The method as in claim 31 further comprising:
a) forwarding each script in accordance with a script order to one or more associated target databases on a same server substantially simultaneously, the server being selected in accordance with an order of servers that contain one or more of the associated target databases, before any script is forwarded to an associated target database that resides on a next server; and
b) repeating the process in (a) for each next server in the order, wherein the server order is included in the code package or determined by the execution engine.

35. The method as in claim 31 wherein the forwarding order may be included in the code package or determined by the execution engine.

36. The method as in claim 30 further comprising:
verifying that a valid connection can be established with each target database associated with the one or more scripts substantially simultaneously prior to forwarding any of the scripts to one or more of the associated target databases.

37. The method as in claim 30 further comprising:
forwarding one or more scripts to one or more associated target databases in accordance with a connection limit, wherein the connection limit is selected from at least the group consisting of: a maximum number of simultaneous connections to all servers and databases, a maximum simultaneous number of connections to each server, and a maximum number of simultaneous connections to each database.

38. The method as in claim 30 further comprising:
forwarding one or more reference queries in the code package to one or more databases, indicated by database identifiers as being associated with a reference query to be forwarded, substantially simultaneously prior to forwarding one or more of the scripts.

39. The method as in claim 38 further comprising:
receiving identifiers in response to a forwarded query; and
forwarding one or more scripts to target databases that are identified by the received identifiers as being associated with each script substantially simultaneously.

40. The method as in claim 30 further comprising forwarding the one or more scripts in accordance with an error policy.

41. The method as in claim 40 wherein the error policy is selected from at least the group consisting of:
stop the forwarding of all scripts to all associated target databases and servers after an error occurs;
stop the forwarding of all scripts to each associated target database where the execution of a script causes an error, after the error occurs;
stop the forwarding of all scripts to a database server that contains at least one associated target database where the execution of a script causes an error after the error occurs;
stop the forwarding of all scripts in a group of one or more scripts to all associated target databases after an error occurs;
stop the forwarding of all scripts in the group of one or more scripts to each associated target database where the execution of a script causes an error after the error occurs; and
stop the forwarding of all scripts in the group of one or more scripts to a server that contains at least one associated target database where the execution of a script causes an error after the error is reported.

42. The method as in claim 40 further comprising instructing each database associated with an error to roll back any changes that were made to that database up until the time that the error occurred.

43. The method as in claim 30 further comprising forwarding the one or more scripts in accordance with a pause policy.

44. The method as in claim 42 wherein the pause policy is selected from the group consisting of at least:
pausing after the execution of a script on each server that contains associated target databases;
pausing after the execution of a script on each associated target database;
pausing after the execution of a script on all associated target databases;
pausing after the execution of a script from a group of scripts on each server that contains associated target databases;
pausing after the execution of a script from the group of scripts on each associated target database;
pausing after the execution of a script from the group of scripts on all associated target databases; and
pausing after an error is reported in response to the execution of one or more scripts.

45. The method as in claim 30 further comprising:
formatting one or more scripts, prior to forwarding said scripts, to match the format of a server that contains an associated target database.

46. The method as in claim 30 further comprising:
forwarding a notification concerning the execution of a forwarded script, wherein the notification concerns at least one of the group consisting of:
an inability to establish a valid database connection, an execution error, a warning, a specific message and a message from a class of messages.

47. The method as in claim 46 wherein notifications may be forwarded by one or more of the group consisting of at least: email, text message, facsimile, voice, and an audible signal.

48. The method as in claim 30 further comprising forming a secure connection with an associated database before forwarding a script.

49. The method as in claim 30 further comprising forwarding one or more scripts in accordance with a schedule.

50. The method as in claim 49 wherein the schedule may be selected from at least the group consisting of: periodically, randomly, on-demand, and at specified dates and times.

51. The method as in claim 30 further comprising generating a secure script.

52. The method as in claim 30 further comprising forming a secure connection with an associated database or server before forwarding one or more of the scripts.

53. A method for accessing multiple databases simultaneously comprising:
receiving one or more ordered datasets in response to a forwarded script from one or more associated target databases, wherein each dataset comprises one or more ordered datatables;
discovering an ordered column schema associated with each received datatable;
discovering one or more common, column schemas within the received datasets; and
aggregating one or more datatables associated with each common, column schema in accordance with an aggregation order policy.

54. The method as in claim 52 wherein the aggregation order policy may be selected from at least the group consisting of:
aggregating datasets according to a received dataset order; aggregating datasets ignoring a dataset order; aggregating datatables according to an order within each received dataset; aggregating datatables ignoring a datatable order within each dataset; aggregating datatables according to an order of columns within each column schema; and aggregating datatables ignoring an order of columns within each column schema.

55. The method as in claim 52 further comprising outputting the aggregated datatables once responses associated with one or more of the scripts have been aggregated along with a label.

56. A method for accessing multiple databases simultaneously comprising:
receiving one or more ordered datasets in response to a forwarded script, wherein each dataset comprises one or more datatables;
discovering an ordered column schema associated with each received datatable;
assigning each ordered column schema to a tag;
assigning each datatable a tag that corresponds to its column schema tag according to an aggregation policy, and
outputting the datatables with the assigned tag in order to display or store the datatables in an aggregated format.

57. A method for accessing multiple databases simultaneously comprising:
receiving a code package that includes one or more scripts and one or more database identifiers, wherein each script is associated with one or more of the identifiers; and
forwarding one or more scripts, to one or more target databases substantially simultaneously, each target database being identified by the identifiers that are associated with each script;
receiving one or more ordered datasets in response to a forwarded script from one or more associated target databases, wherein each dataset comprises one or more ordered datatables;
discovering one or more common, column schemas within the received datasets and detecting one or more common column schemas within the received datatables; and
aggregating one or more datatables associated with each common, column schema in accordance with an aggregation order policy.

58. The computer readable medium as in claim 29 further comprising:
a code package unit operable to generate the one or more scripts and one or more database identifiers.

59. The computer readable medium as in claim 1 wherein the medium is part of a controller.

60. The computer readable medium as in claim 59 wherein the controller comprises a computer.

61. The computer readable medium as in claim 29 wherein the medium is part of a controller.

62. The computer readable medium as in claim 61 wherein the controller comprises a computer.

63. The method as in claim 57 further comprising:
generating the one or more scripts and one or more database identifiers.
